(19) United States
(12) Patent Application Publication
(10) Pub. No.: US 2023/0412619 A1
(43) Pub. Date: Dec. 21, 2023

(54) SYSTEMS AND METHODS FOR THE INSTRUMENTATION, REAL-TIME COMPROMISE DETECTION, AND MANAGEMENT OF INTERNET CONNECTED DEVICES

(71) Applicant: Sternum Ltd., Tel Aviv-Yafo (IL)

(72) Inventors: Natali TSHOUVA, Hod Hasharon (IL); Lian GRANOT, Hod Hasharon (IL); Dean ZAVADSKI, Hod Hasharon (IL); Noam ZHITOMIRSKY, Hod Hasharon (IL)

(21) Appl. No.: 18/210,928

(22) Filed: Jun. 16, 2023

Related U.S. Application Data
(60) Provisional application No. 63/352,843, filed on Jun. 16, 2022.
(60) Provisional application No. 63/521,289, filed on Jun. 15, 2023.

(51) Int. Cl. H04L 9/40

(52) U.S. Cl. CPC H04L 63/1416

(57) ABSTRACT

A method for protecting an embedded device comprising a processor and configured for connection to a network comprises obtaining at least part of a program configured to operate the device; modifying the program to create a protected program including one or more additional program elements that provide at least one aspect of protection against a known threat or attack; saving the protected program to a data store; and providing the protected program to the device for subsequent execution by the device processor.

### 1 CROSS-REFERENCE TO RELATED APPLICATION

This application claims the benefit of U.S. provisional patent application no. 63/352,843 filed Jun. 16, 2022 and claims the benefit of U.S. provisional patent application no. 63/521,289 filed Jun. 15, 2023, all of which are incorporated herein by reference for all purposes.

### 2 COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2023, STERNUM, Ltd.

### 3 BACKGROUND OF THE TECHNOLOGY

### 3.1 Field of the Technology

The exemplary, illustrative, technology herein relates to systems, software, and methods for the instrumentation, management, and protected operation of internet-connected and network-connected devices, specifically for the mitigation and management of malicious-actor attacks on deployed “internet of things” devices and network appliances (collectively, unprotected devices) such as where the manufacturer does not provide persisted monitoring, management, and remediation components or such persisted monitoring, management and remediation is inadequate or compromised. The technology described herein further provides methods of automatically instrumenting and monitoring the performance of “internet of things” devices and remediating compromised devices.

### 3.2 Related Art

The “Internet of Things” is becoming ubiquitous. Doorbell cameras now monitor activity in front yards, one can check the status of and control their HVAC thermostat and refrigerator with their smart devices, cars provide telematics for status updates to an insurance tracking server, and smart watches can be used to pay at points of sale.

A common characteristic of such embedded devices at the time of this filing is that they are often relatively inexpensive and designed to be highly efficient both in energy usage and in task performance. An illustration of an example network-connected IoT device is shown in FIG. 1. Lower capability processors are often used to save on cost and power. Such lower capability processors often require coding efficiencies and disciplines that in the distant past were usually applied to many computing platforms but have since mostly fallen by the wayside as processor performance of more capable computing platforms has increased. Thus, a typical embedded device with a low capability processor may often execute a single (or small number of) executables, usually stored as firmware in flash memory. There may be no operating system at all, or any operating system that does exist may be very thin and perform only basic functions such as communications and input/output. There is typically no room or processing capacity for a separate anti-virus/anti-spyware security program (updated periodically with a changing/expandable protection file recognizing attack signatures) that could locally monitor the device and protect it from attacks. The most that is typically provided is a user-initiated or other mechanism for downloading and storing updated firmware and rebooting the device using the new firmware.

Currently, such unprotected devices provide an attractive attack target for malicious actors looking to compromise devices connected to public networks. An attacker can often gain control of the device remotely and begin using it for their own purposes. The compromised devices can, for example, be used by the attacker for further network attacks or to provide surveillance of the networks to which they are attached. Or the attacker can simply patch into the device's output stream to allow the attacker to nefariously intrude into the lives of those using the devices. The results can be embarrassing or worse: for example, an attacker taking control of pipeline or power grid control devices or autonomous vehicle controllers can cause mayhem and create disasters.

An attacker can use various kinds of attacks against such devices. One of the most effective attacks is a code-level exploit that takes advantage of discovered weaknesses in the code that controls the device. Unlike personal computers and many smart devices that constantly receive operating system and security updates and thus have substantial defenses against attack, these embedded devices are often not connected to any management system that can adapt to new attacks by automatically updating/installing active protections against code-level exploits (converting the unprotected device to a protected device), monitor the operating devices for performance and compromise, detect and remediate attacked devices after they are deployed, and/or customize the protections provided in response to evolving or discovered threats. Nor do they have significant or substantial native protections built into them to ward off attacks from even older or known existing threats.

Numerous techniques have been developed to detect various types of attacks based upon vulnerabilities encoded within device firmware. These techniques are typically applied at source code compilation time, post-compilation and pre-link time, or to the post-linker executable. They share the characteristic that the attack mitigations are pre-programming into each executable, often resulting in slower device execution. But there are still many challenges, especially for embedded processing devices.

For example, there are many types of network-based attacks against network connected devices, including attacks against the stack, the heap, parameter expansion, and the like. Unlike known single point protection schemes, adding protections against a plurality of attacks into a firmware or other executable is far more complex than simply accreting the protection techniques applied to an executable because of the known challenges of interference between the various insertion techniques and the negative effects upon the device performance that result from a plurality of protection techniques operating within the resulting executable. In many cases applied to embedded systems, the simplistic accretion of protection techniques might make logical sense but ends up altering the execution performance to make the device demonstrate poor response times, or even cause the device to fail to function properly. This problem is well understood, resulting in a variety of techniques to apply small or incremental changes to program executables that minimally disrupt application timing. However, many known techniques simply cause the device to fail when several techniques are sequentially applied to an executable. For example, techniques that rely upon the replacement of “timing” instructions (e.g., NOP or similar instructions) fail to apply in the absence of these instructions, and sequential application of techniques that rely upon this style of replacement technology fail when the supply of replaceable instructions is exhausted by previous applications of protections. Furthermore, existing attack detection technologies, once added to an executable, cannot be enabled and/or disabled “on the fly” on an “as needed” basis, so the monitoring overhead and performance penalties persist even when the need for monitoring and remediation of a specific attack changes to be less acute and higher processing performance is now desired.

In addition, existing network connected devices may not support ongoing, persisted telemetry techniques that permit reliable, intermittent network communications between the device and a server or other device(s) that are configured to monitor and manage the security of the network connected device, so the identification of compromised devices is made more complex, forcing users to utilize a manual process performed post-facto by human analysts. Additionally, there are typically no means to adjust the protections applied to a network connected device in real time, nor to recover attacked (and possibly compromised) network connected devices to restore their uncompromised functionality short of replacing the device.

Thus, while much work has been done in the past, attackers are ingenious and are constantly coming up with new ways to attack network connected devices. Accordingly, further improvements are needed.

### 4 SUMMARY OF THE TECHNOLOGY

The described systems and methods address these ongoing problems and provide effective solutions that improve the operation of network connected devices by adding the ability to dynamically manage and control a plurality of attack detection and remediation techniques in a running device, to alter the execution of the device, and to recover attacked devices from detected attacks and/or compromises.

### 5 BRIEF DESCRIPTION OF THE DRAWINGS

The features of the present technology will best be understood from a detailed description of the technology and example implementations thereof selected for the purposes of illustration and shown in the accompanying drawings in which:

FIG. 1 depicts an exemplary prior art network connected embedded device.

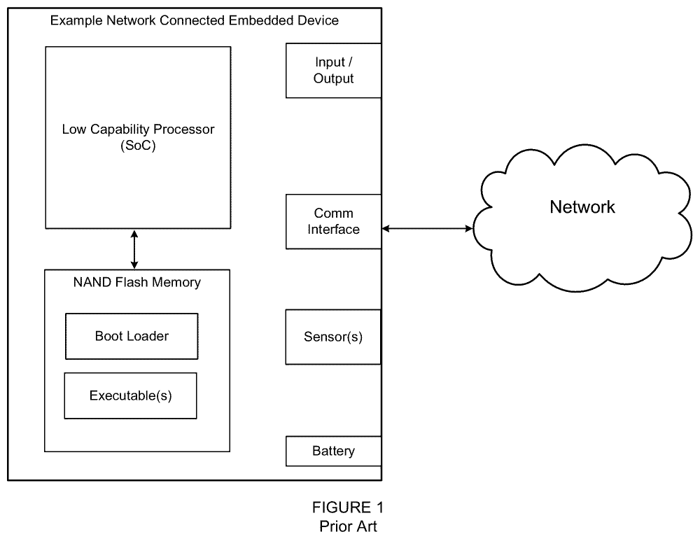

FIG. 2 depicts an example architecture comprising one or more PES connected to one or more communicatively connected networks, where the PES manages the vulnerabilities of one or more protected devices.

FIG. 3 illustrates an exemplary system of the technology, including a plurality of protected and unprotected devices and a plurality of PES servers.

FIG. 4 depicts an exemplary protection enabling server (PES) of the described system.

FIG. 5 depicts an exemplary machine-learning implementation of a PES of the described system.

FIG. 6 depicts an exemplary protected device 100 of the described system, where the protection comprises individual executables (programs) added to the device by the PES.

FIG. 7 depicts several configurations of exemplary protected programs of the described system.

FIG. 8 depicts the before and after configuration of an exemplary dynamically protected program of the described system.

FIG. 9 depicts an exemplary control specification structure of the described system.

FIG. 10 depicts an exemplary telemetry data structure of the described system.

FIG. 11 depicts unprotected and protected device communications with the PES of the described system.

FIG. 12 depicts a process flow for device initialization according to the described system.

FIG. 13 depicts a process flow for program inspection according to the described system.

FIG. 14 depicts a process flow for the program inspection program according to the described system.

FIG. 15 depicts a data structure for command injection parameter data elements according to the described system.

FIG. 16 depicts a process flow for command injection according to the described system.

FIG. 17 depicts a process flow for handling of telemetry data according to the described system.

### 6 DESCRIPTION OF SOME IMPLEMENTATIONS OF THE TECHNOLOGY

### 6.1 Overview

The described systems and methods describe an architecture and exemplary systems implementation for advanced protection, monitoring, and ongoing remediation of internet and other network connected devices. Network connected devices include, for example, Internet of Things (“IoT”) devices such as cameras and sensors, as well as dedicated network appliances such as switches, routers, and firewalls. Unlike some other network connected computing systems, embedded network connected devices are generally characterized as having either no operating system (e.g., required OS functions are included in the program executable) or having an embedded operating system that boots from firmware stored in non-transient storage such as ROM, PROM, or EEPROM. In some cases, network connected devices boot from the network after booting a network-aware program loader application from non-transient storage.

Example non-limiting technology herein protects from attack, embedded or other processing devices having at least one processor that executes a program stored in non-transitory memory. Example technology provides protection elements to the program, the protection elements detecting and/or defeating attacks and using telemetry to report the attacks to a remote computing device. A specification can be provided to the device to selectively activate and deactivate protection elements on a dynamic, as-needed basis.

An aspect of one implementation comprises a method or device for protecting an embedded device comprising a processor and configured for connection to a network, comprising: obtaining at least part of a program configured to operate the device; modifying the program to create a protected program including one or more additional program elements that provide at least one aspect of protection against a known threat or attack; saving the protected program to a data store; and providing the protected program to the device for subsequent execution by the device processor.

Modifying may comprise including first and second protected program elements and/or protected program modules in the program, the first and second protected program elements and/or protected program modules respectively effective to detect and/or stop different network attacks against the program operating the device. Modifying may include configuring the first and second protected program elements and/or protected program modules, thereby allowing differing protected program elements to be dynamically enabled or disabled in accordance with a capability enabling specification.

The capability enabling specification may comprise a protected program element and/or protected program module. An external device may provide the capability enabling specification to the device.

Modifying may comprise including a protected program module configured to create a persisted telemetry function.

Modifying may comprise including a protected program module configured to create a persisted command and control function.

Modifying may comprise including a protected program element and/or protected program module configured to enable or disable one or more protection functions provided by protected elements included in the device.

The modified protected program may be provided to the device before deploying the device on a network and/or after the device boots and connects to a network.

At least one program element and/or program module may be provided to the device after the device is deployed and connected to a network.

The protected program may be provided to the device as a shared library and/or as a binary executable.

Modifying may include replacing one or more protected program elements and/or program modules without recreating the protected program.

One implementation of a method for operating a protected device and/or such a protected device including a processor and connected to a network comprises providing a protected device comprising at least one protected program effective to provide at least one aspect of specification-defined protection against network-based attacks; and executing the protected program on the protected device processor in accordance with a specification to protect the protected device from network-based attacks.

The protected device may be formed by downloading the protected program into the device. The protected program may be downloaded into the device when the protected device is booted and connected to the network. The protected device may be updated by downloading a protected program element into the device after the device is deployed. Downloading may comprise downloading a shared library.

At least one remote computing device may provide protection-related services. The protected program may create a persisted telemetry function configured to communicate with the remote computing device. The persisted telemetry function may communicate metrics or suspected attack notifications from protected program elements of the executing protected program. The persisted telemetry function may transmit at least some of the metrics or suspected attack notifications to the remote computing device.

The protected program may create a persisted command and control function. The persisted command and control function may communicate with the remote computing device and receive control instructions from the remote device and/or implement one or more instructions received from the remote device. Detection results may be provided to the persisted telemetry function.

The device may take an action to prevent execution of a detected attack such as pausing or terminating a current execution of the protected program and/or transferring control from the protected program to the command and control program element and/or performing one or more actions specified by the command and control program element and/or performing at least one action specified in a capability enabling specification.

These and other aspects and advantages will become apparent when the Detailed Description of Example Non-Limiting Implementations below is read in conjunction with the accompanying Drawings.

### 6.2 Exemplary System Architecture

### 6.2.1 Overview

The described technology provides a system and method for protecting, managing, and remediating deployed vulnerabilities within network connected devices with respect to anomalous execution behaviors created by malicious attacks by external actors. The protecting aspect may include the detection, identification, and proactive interruption of anomalous program behavior, operating conditions, and/or unexpected program states within the protected device. The managing aspect may include one or more of monitoring aspects including data collection of detection, identification, and interruption data, management and analysis of this data, and determinations related to whether the data represents an attack, anomalous behavior requiring further intervention, or whether the detection represents program exceptions and anomalous behaviors that do not require additional intervention. The remediation aspect comprises correcting (remediating) the device and adjusting the device's operating protection(s) in response to the detected behavior and/or the detected behavior(s) of other network devices. In a simplified example, some the described technologies are embodied in a computer server located on a network (e.g., a protection enabling server, or PES) that provides network services to devices connected to a network that implement one or more of the described protection technologies, and protected devices (e.g., IoT devices) that comprise one or more programs that have been protected using techniques and methods described herein and interoperate with the aforementioned PES. Collectively, the attack detection and protection, reporting, and remediation technologies installed in network connected devices are called protection techniques and are described in more detail below.

One aspect of the described protection techniques is that they may be configured to implement varying types of attack protection to an existing, previously unprotected device, even if the unprotected device was not originally configured to operate with such protection. Alternatively, the protection technologies may be used to install attack protections into executable components that are subsequently integrated with a network device. The modified device and its protections may include telemetry, control, and control specification handling functions, in addition to specific protections against discrete network-based attacks.

An aspect of the described technology includes the application of protection techniques, in single and in plural, that convert an unprotected device into a protected device by modifying the device's executables, either by inserting executable code that implements one or more aspects of a protection technology, generally called program elements, into the device's existing software, or by adding individual programs (executables) to the device's collection of programs that are executed. These modifications permit devices not originally designed by the manufacturer to include protection, monitoring, and remediation functions to communicate with one or more services provided by a PES.

An aspect of the described technology is the application of ongoing updates to protected program executables to address changing and new threats to the device integrity. These updates may be integrated into a protected device on an as needed or ad-hoc basis, without disabling the device or requiring it be decommissioned, updated, and then returned to the field.

In a first simplified example, the application of protection techniques occurs by replacing the current unprotected program(s) of the device with one or more protected programs previously identified as operable with the unprotected device and by providing the previously protected program to the device. In a second simplified example, the application of protection techniques includes the identification of the protection technologies and application methods that are currently appropriate to a specific device and/or program, the application of those protection technologies to the device's program in a manner that does not unduly degrade the performance of the device and providing the now protected program to the device. More complex application of protection technologies includes adding anomalous condition detection handling, remediation, and protection configurability to the device. Multiple variations of these application techniques are described below.

Note that certain non-limiting exemplary approaches herein differ from existing host-based security systems (e.g., anti-virus, host-based network attack detection) that such older technologies intercept the incoming network traffic and inspect it, or inspect files stored on the device for known signatures, unlike non-limiting embodiments of the current technology that detects attacks as they occur within an running program.

An aspect of implementing the protection technologies is the selective inclusion of protection techniques within protected devices, and the ability to enable and disable included individual techniques in a running device as threat and operational conditions warrant. In addition, in some implementations, the protection technologies may be updated “on the fly” to include new functionality and detection capabilities as described herein, without requiring a new protected program.

A further aspect of implementing the protection technologies is the optional inclusion of a persisted telemetry function (e.g., included program elements) within protected devices that enhances the capabilities of the device to gather and report operating data (metrics, program states, and related data, collectively called telemetry data), collects and processes the telemetry data to determine if an attack is occurring (or has occurred), and to make determinations as to whether additional actions are required to stop or remediate the attack. In one implementation, the operating protected device collects device operating metrics, including program execution states, and attack reports from attack detectors, and transmits the collected telemetry data to one or more PES. The transmitted telemetry data may be compressed, filtered, or summarized for transmission, and may be further augmented with information about the protected device and its configuration. The PES processes the received telemetry data, identifies anomalies in that data that indicate whether there is (was) an external attack upon the network device. If an attack is detected, the PES identifies the attack type, and determines a course of action, which it then communicates to the protected device. The protected device's control function optionally uses control specifications stored in a memory of the protected device to take specific action against the attack. In some instances, the PES supplies additional control specifications or specification updates to the protected device, and optionally pushes them to other protected devices that are identified as being “at risk.” In alternative implementations, one or more detection and response steps may be performed by the device upon detection of the attack, with the transmission of telemetry data occurring after the attack has been responded to.

One of the challenges of adding persisted telemetry to network connected devices that were not designed to include telemetry functions, those that have intermittent connections to a telemetry data receiving system is that the collection, processing, and transmission of telemetry data function was not incorporated into the control and timing processes of the initial device program(s). Thus, the telemetry aspects of the system may be added into the existing device executable programs in a manner that limits their impact on the operation of the device, that permits timely processing and transmission of telemetry data, and that manages the volume of telemetry data between the device and the receiving system, without interfering with the operation of the device (unless an exception is detected).

In some aspects of the described technologies, the monitoring functions are integrated with the telemetry functions. The monitoring function may take several forms, depending upon the nature of the device being protected. The described technologies described permit the distributed processing/monitoring of telemetry to be allocated to the devices and servers where it is most effective and operates to protect the protected devices. Part of the requirements for monitoring, detection, and protection aspects of the system may operate even when the network is not fully operable, unlike systems like Alexa which fail if the cloud service is intermittently not reachable over the internet.

Post monitoring, the response functions of the described technologies determine the response of a protected device (and of the set of protected devices in communication with a PES) to one or more detected attacks. Like the monitoring functions, aspects of the response functions may be performed by a protected device and/or by a server using (monitoring) the received telemetry data. Device level responses are often limited due to device-level resource constraints. The responses may be performed under control of a response control specification, where device-class and/or device-specific response specifications may be downloaded into the device before the attack and the device responds in accordance with the configuration defined in the specification(s) at the time of attack. For example, if an attack is detected, the device may be instructed (by the specification) to halt processing, disable all network interfaces other than the connection to a monitoring server, and then revert to a “monitor mode” awaiting instructions from the monitoring server. Alternatively, the device may be instructed to restart and enter a monitor mode. Additional specifications may be downloaded into the protected device on an as-needed basis, at device (re)boot, or in response to a detected anomalous behavior, to more fully identify, report, and remediate the device and its anomalous behavior.

In some aspects, the telemetry data is written to a database by the PES, and a PES program processes that database to identify patterns of anomalous behaviors and common anomalous behaviors/attacks (indicating an attack program being run by a malicious actor designed to identify and compromise a set or class of vulnerable devices) by a malicious actor. The PES may then determine a set of responses to be undertaken by one or more of a plurality of the identified network connected devices at the PES is in communication with. The response information is provided to the network connected devices as updated control specifications and/or updated software components to improve the security and defensive posture of a set of identified devices.

Optionally, a PES (or sufficiently powerful network connected device) can use machine learning (ML) techniques to train and utilize ML models to assist with the control function in identifying and classifying intrusion types, refining the network connected devices' ability to respond to external attacks by delivering updated control specifications and/or software components to devices with a connection to the PES. In some implementations, the ML techniques identify one or more devices that require updating and the PES updates the devices the next time the device(s) connect to the PES.

### 6.2.2 Architecture

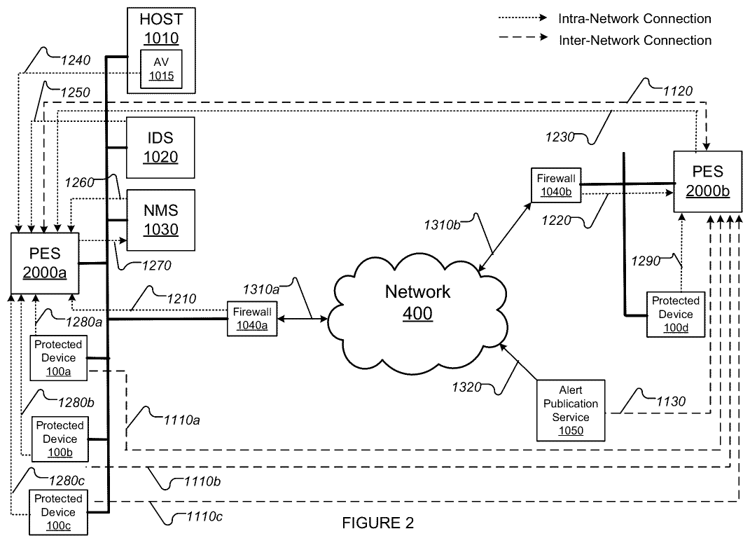

FIG. 2 depicts an example architecture comprising one or more PES (2000a, 2000b) deposed on one or more communicatively connected networks, where the PES manages the vulnerabilities of one or more protected devices (100a, 100b, 100c, 100d). As shown, the communicatively connected networks may be further connected using a wide area network, such as a network like the Internet or a wide area private network.

Deposed on the first network, there are several malicious behavior network monitoring systems, including a) host 1010, further comprising an active anti-virus software (1015) that checks the host and downloaded materials to that host for malicious payloads and files, b) Intrusion detection system (IDS) 1020, which monitors the network for network traffic that indicates a compromised device is present on the network and/or that a malicious payload has been included in a network session, and c) a network management system (NMS 1030) which receives alerts from a PES (e.g., PES 2000a) and reports known device issues, including lost connectivity and related network-based issues. The PES (2000b) may also receive alerts and notifications from other PES (e.g., PES 2000a). These reporting links are illustrated in FIG. 2 with dashed lines for inter-network connections, and with dotted lines for intra-network connections.

The PES 2000a supports receiving reports from a variety of network-based sensors in addition to receiving reports from protected devices. These reports are received by the PES and processed by the PES to provide a more comprehensive view of the network threats present in the operating environment of the PES and its associated protected devices. One example of a host-based sensor is a host-based antivirus software (1015) operating on Host 1010 (e.g., a laptop, desktop, server) that is connected to the network and detects and transmits reports of malicious attacks and/or virus infections of that device to PES 2000a. These reports are typically made using the network, or out-of-band using communications ink 1240. Similarly, IDS 1020 represents an example of a typical network-based sensor that monitors network traffic and transmits detection reports of network-based malicious activity to PES 2000a, again transmitting these reports over the network or along out-of-bank communications link 1250. Similarly, Network management system (NMS) 1030 transmits system operations anomaly reports received or derived from network operation monitoring activities to PES 2000a, again over the network or along out of band communications link 1260. The PES 2000a may optionally transmit protected device operational status information (e.g., device attack detected) to NMS 1030, again over the network or along out-of-band communications link 1270. In addition, Firewall 1040a may detect network-based malicious traffic and transmit reports of this traffic to PES 2000a over the network or along out-of-band communications link 1210. Protected devices 100a-c report attack detection reports to PES 2000a either over the network or along the respective out-of-band communication links 1280a-c. Protected devices 100a-c may also report attack detection reports to PES 2000b in similar ways (e.g., over the network or along out-of-band communication links 1110a-c). In a second network, Firewall 1040b transmits network-based malicious traffic detection reports to PES 2000b. Protected device 100d transmits attack detection reports to PES 2000b, again over the network or along out-of-band communications link 1290. PES 2000b may transmit some or all of the received detection and attack reports, or information derived from these reports, in addition to information about updated vulnerabilities and updated protected item elements to PES 2000a, either over the network or along out-of-band communications link 1230. Similarly, PES 2000a may transmit some or all of the received detection and attack reports, and information derived from these reports to PES 2000b, as well as updates to protected elements, and information about vulnerabilities and attacks against specific types of devices and specific remediations associated with specific protected elements. External reporting sources, such as Alert publication service 1050 may transmit similar information to a PES (e.g., PES 2000b). Additional networks, devices, sensors, and PES servers may be added to the example configuration without departing from the scope of this disclosure.

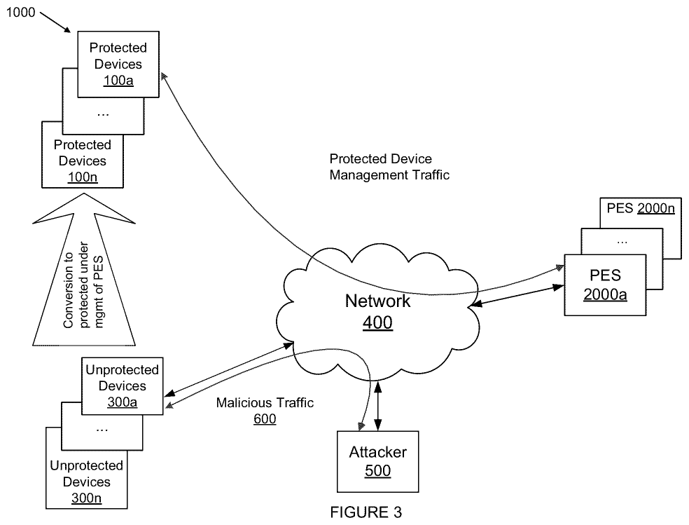

FIG. 3 depicts an example system implementing the technology (1000). The system consists of one or more protected devices (100a, . . . , 100n) that are communicatively connected to one or more protection enabling servers (PES) (2000) using a network (400). Each PES may be implemented as a single computer server (e.g., 2000a), or a cooperating cluster of servers as depicted as PES, and/or a plurality of PES (2000a, . . . , 2000n as depicted in FIG. 2) each implementing one or more device protection-related applications as described herein. PES and their programs are described in more detail below. Unprotected devices (300a, . . . , 300n) are also depicted.

Attacks against protected devices from malicious actor's computers (not shown) arrive over the network and are directed against a protected device's network connection endpoint. For example, a network device may make an TCP/IP-HTTP (or HTTP/S) port available for connection by outside parties. The malicious actor (500) connects to the available port to start their attack and provides unexpected inputs to cause the program to malfunction and enter an anomalous state. Note that the use of the HTTP (or HTTP/S) port is a non-limiting example; any open network port may be used as an attack vector. In some instances, the attack is successful, where success causes the network connected device to execute an abnormal behavior, either by changing program state, over-writing memory, changing program execution paths, and the like. In an unprotected device, this results in the device becoming compromised, often under the control of the malicious attacker. In a protected device, the attack is detected by detecting the anomalous behavior and the attack is immediately stopped. Once devices exhibiting anomalous behavior(s) are detected, they can have the program defects that permitted the attack to succeed repaired and the device can be returned to service.

Note that this functionality of the described technology operates even when the protocol is encrypted (such as HTTP/S), as the protection occurs within the protected device and not at the protocol layer as is performed by anti-virus applications such as those provided by McAfee or Norton.

### 6.2.2.1 Protection Enabling Server (PES) (2000)

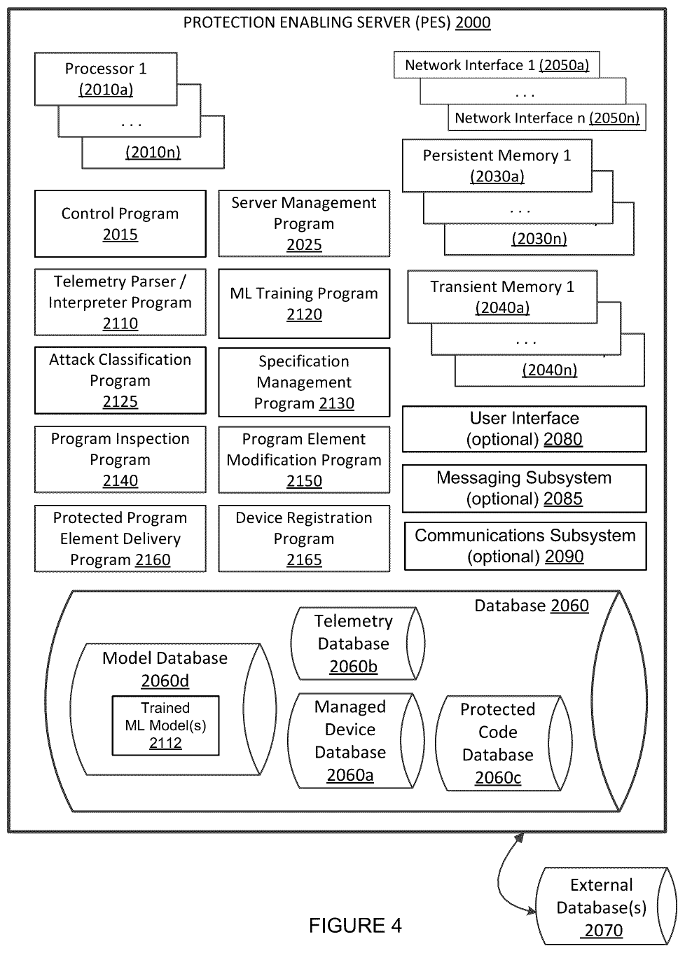

FIG. 4 depicts a protection enabling server (PES) of the technology. Each PES (2000) can include one or more processors (e.g., 2010a, . . . , 2010n) (either general purpose CPUs and/or specialized processors such as FPGA, GPU, ASIC, etc.), operably connected to one or more persistent (e.g., 2030a, . . . , 2030n) and/or transient (e.g., 2040a, . . . , 2040n) memories. The transient and/or persistent memories are used to store information being processed by the system and/or to store various program instructions (collectively programs) that are loaded and executed by the processor(s) to perform the PES operations described herein. The processors and memories are further operably connected to one or more networking and communications interfaces (e.g., interfaces 2050a, . . . , 2050n) appropriate to the deployed configuration.

Persistent memory(ies) includes one or more of disk, PROM, EEPROM, flash storage, and related technologies characterized by their ability to retain their contents between on/off power cycling of the computer system. Some persistent memories can take the form of a file system for the PES and can be used to store control and operating programs and information that define the way the PES operates, including scheduling of background and foreground processes, as well as periodically performed or event-driven processes. Persistent memories in the form of network attached storage (persistent memory storage that is accessible over a network interface) also can be used without departing from the scope of the disclosure.

Transient memory(ies) can include RAM and related technologies characterized by the contents of the storage not being retained between on/off power cycling of the PES.

The network interface(s) are operated under control of the processor(s) and the processing instructions contained within the control and operating programs mentioned below. These interfaces provide a connection to wired and wireless networking products that operably connect the PES(s), data sources, protected and unprotected devices, and network services described herein. One or more network interface(s) can be connected to ethernet-based networks (either wired or wireless), specialty networks and non-standard interconnection schemes such as CANbus, or can be connected using specialized wireless technologies (such as Bluetooth, zigbee, or z-wave). The network interface may connect to the first link of a chained or mesh network, such as a Bluetooth connection to a router, mesh device, or cell phone functionally acting as a router, and wireless or broadband connections from the functional router to a LAN or WAN. In addition, the network connection may provide intermittent connectivity. For purposes of clarity, each network interface (2050) is illustrated as a separate interface but can be implemented as one or more distinct interfaces if desired.

The PES can have an optional user interface (2080) provided by a user interface program. The user interface optionally connects to an onboard or external display (not shown), comprising one or more of an LCD panel, LEDs, a small OLED screen, or any other means of displaying information to the user, optionally may be network based via one or more of the network interfaces, or may be implemented as a combination of connected to both a display and network interface). The user interface also optionally includes or connects to control hardware or software comprising a touch screen, buttons, switches, dials, motion detectors, voice recognition detectors/programs, user input using a specific user interface program, or similar. For example, in some implementations, the user interface comprises a touch screen. In other example implementations, the user interface comprises a web server interface.

Application and systems programs are computer software programs that are stored in a memory of the PES and are executed by a processor of the PES to provide the specialized logic that converts a general computerized processing platform into a custom computer-controlled machine that performs various aspects of managing protected devices. The functionality of one or more programs may be combined into an aggregate program without loss of functionality. The programs supported by the PES can include those listed below in Table 1:

TABLE 1

| PROGRAM | DESCRIPTION |
|---|---|
| Control | The control program can be a standalone program or an operating |
| program (2015) | system (OS) like Linux. The control program provides the |
| | network interface drivers, and optionally executes a plurality of |
| | other programs or program modules in order to perform the |
| | various functions of the PES. |
| Server management | One or more programs for providing server management |
| program (2025) | information utilizing a web services interface or other dedicated |
| | management information reporting systems such as SNMP for |
| | purposes of providing management information useful to report on |
| | the operation of the PES. |
| Messaging | One or more message notification and alerting program(s), which |
| subsystem (2085) | facilitate inter-process and inter-server messaging and notification. |
| | Examples of these programs include operating system provided |
| | inter-process communication facilities (IPCs) and third-party |
| | messaging middleware subsystems such as MQ from IBM. The |
| | PES also can include scheduling programs, such as “cron” on |
| | Unix systems or scheduled tasks on Windows systems, which are |
| | used to run specific programs on a periodic or scheduled basis. |
| Communications | The communications subsystem comprises one or more programs |
| subsystem (2090) | that are used to send messages and/or telemetry data between |
| | protected devices connected to the PES and one or more PES |
| Telemetry | The telemetry parser/interpreter program receives and examines |
| parser/interpreter | the telemetry data received from each protected device and |
| program (2110) | determines if the device is behaving in an expected or anomalous |
| | manner. Anomalous behavior is saved as execution exception |
| | data. |
| Machine learning models | One or more trained machine learning models, used for detecting |
| (trained) (2112) | attacks in received telemetry data. |
| Machine learning training | One or more programs used to train machine learning models |
| program (2120) | based upon attack information stored in a database of the PES. |
| Attack classification | The attack classification program receives and examines the |
| program (2125) | execution exception data and determines if the received data |
| | matches a known type of external attack by comparing the |
| | received data to known attack signatures stored in a database. |
| | Attack types may also be matched with execution exception data |
| | are saved in a database. |
| Specification management | The specification management program generates and saves a |
| program (2130) | control specification or modifies and saves an existing control |
| | specification associated with one or more protected device(s). |
| Program inspection | One or more programs that inspect programs to determine how |
| program (2140) | they may be modified in order to protect them, and the appropriate |
| | protections to be applied. |
| Program element | One or more programs that apply the determined protections to |
| modification | one or more received programs to create protected program |
| program (2150) | elements and protected programs. |
| Protected program element | A program that delivers protected program element(s) and |
| delivery program (2160) | protected programs to a device. |
| Device registration | A program that manages device registration, identification, and |
| program (2165) | protection status in a database of the PES. |

Each of these programs and their functionality is described in detail below.

### 6.2.2.1.1 Control Program (2015)

The control program of the PES provides basic task scheduling, dispatch, communications interface support, and executable loading services to one or more programs that are executed by the processors of the PES. The control program may also provide storage and memory management, including memory protection, disk-like storage, and network interfaces support. In some implementations, this support is provided by a commercial operating system such as Linux, QNX, Microsoft Windows, and the like.

The PES control program(s) also may include scheduling programs, such as “cron” on Unix systems or scheduled tasks on Windows systems, which are used to run specific programs on a periodic or scheduled basis.

### 6.2.2.1.2 Server Management Program (2025)

The server management program(s) may provide server performance and management statistics using a web interface (via the network interface), and dedicated management system reporting using standard-based reporting techniques such as SNMP and SMTP. The server management programs send information about the performance of the PES to other computers on the network and receive performance information from other computers and protected devices on the network using these and similar protocols.

### 6.2.2.1.3 Database and Database Programs (2060)

One or more databases (e.g., aggregate database 2060, or distinct database instances 2060a, . . . , 2060h) are stored within persistent memories of the system. These databases are used for the storage of information collected and/or calculated by the PES and read, processed, and written by the processors (2010) under control of one or more application program(s). The system database (2060) is illustrated as an aggregate instance of disparate database instances used by the one or more database programs (instance 2060, (database programs not shown for clarity). The PES also can be operably connected to one or more external databases (either storage, instance, and or program, collectively external database 2070) via one or more of the network interfaces. External database (2070) can comprise one or more instances of the system database (2060) that are provided on different computing hardware, or a third-party database provided by a commercial vendor (not shown).

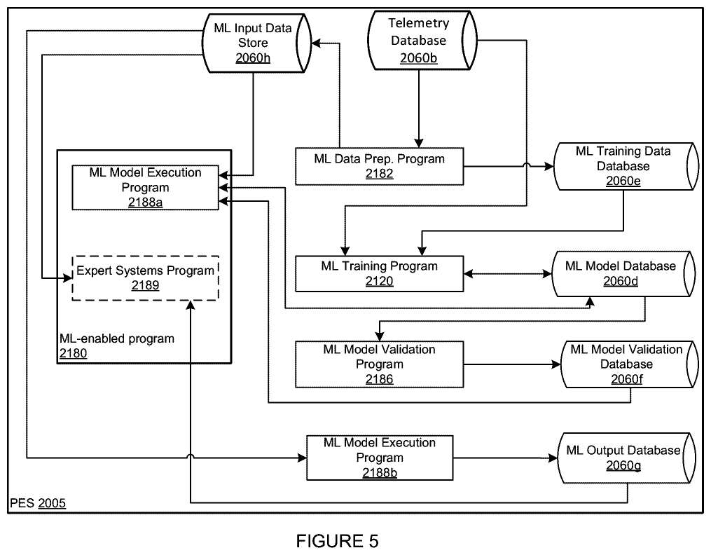

The PES supports one or more database programs that implement the defined database instances as described herein. As described above, one or more database instances are stored within at least one persistent memory of the system and are managed by one or more database programs. Each database and database instance are considered as logical parts of a system database (2060, with instances 2060a, 2060b, 2060c, 2060d, 2060e, 2060f, 2060g, 2060h illustrated in FIGS. 4 and 5), shown in aggregate for clarity. Types of databases may include local file storage, where the file system includes the data storage and indexing scheme, relational database(s) (such as those produced commercially by the Oracle Corporation, or MySQL), object database(s), object relational database(s), NOSQL database(s) (such as commercially provided MangoDB), or other database structures such as indexed record structures like ISAM or VSAM. The databases can be stored solely within a single persistent memory, or can be stored across one or more persistent memories, or can even be stored in persistent memories on different computers.

In an example implementation, the PES utilizes the following database instances, as listed in Table 2 below, structured as either single or multiple instances within a system database (e.g., database 2060):

TABLE 2

| DATABASE | DESCRIPTION |
|---|---|
| Protected devices | This database is used to store unique IDs assigned by the |
| ID database | PES to the protected devices it is monitoring. |
| Execution | This database is used to store telemetry data. Telemetry |
| exceptions | data comprises raw telemetry data, anomalous |
| database | indications, and execution exceptions generated by |
| | protected devices during their operation The PES |
| | classifies exceptions as being anomalous or not |
| | anomalous and stores the exceptions and their |
| | classifications in the database. |
| | This database is also used to store information |
| | corresponding to type of external attack that would cause |
| | the exceptions identified by the system, and |
| | corresponding response(s) taken by the system (such as |
| | specific control specification changes). |
| Control | This database is used to store pre-defined control |
| specification(s)/control | specification(s), and control specification(s) and control |
| specification | specification fragments generated by the control |
| fragments database | specification generation/modification program. |

In an example implementation, the protected device database further comprises information related to protected devices, including one or more of the following data elements:
MAC address
Device ID/type
Preferred network/subnet
Last boot/reboot time
Protected executable ID and version
Protected device configuration ID and version
Protected device configuration parameters

The protected device database has entries added and removed by an automated process(es) of device identification/registration during the PES processing of initial device connections with the PES (as described below). The protected device may also be updated from a user interaction where the user manually enters protected device information into the database.

### 6.2.2.1.4 Messaging Subsystem (2085)

A messaging subsystem (2085) provides an optional method for the PES to send and receive messages and/or telemetry data using standard messaging systems. If used, the messaging subsystem comprises one or more message notification and alerting program(s), which facilitate inter-process and inter-server messaging and notification. Examples of these programs include operating system provided inter-process communication facilities (IPCs) and third-party messaging middleware subsystems such as MQ/MQDT from IBM (and others).

### 6.2.2.1.5 Communications Subsystem (2090)

A communications subsystem (2090) comprises an optional method for the PES to send messages and/or telemetry data to other parts of the network, and to receive operating information results and messages from protected devices. The communications subsystem comprises one or more programs that send and receive control messages and/or telemetry data between devices connected to the PES, the PES, and optionally to other systems connected to the network. In an implementation, the communications subsystem uses a dedicated message transport (e.g., a REST-style interface between the device and the PES). In other implementations, the messaging subsystem uses an IoT message broker protocol such as RabbitMQ, EMQ X, and VerneMQ, or the above described MQDT aspects of the messaging subsystem.

In typical use, devices on the network that are connected to the PES take measurements of the device operation metrics and attack indications and report these data elements to the PES using the communications subsystem. Alternatively, the device can report its measurements to a local controller, where the measurements are forwarded to the PES by the controller using the communications subsystem.

### 6.2.2.1.6 Telemetry Parser/Interpreter Program (2110)

The telemetry parser/interpreter program receives device telemetry data, parses it, and interprets the received data to classify whether the device is behaving in an expected or anomalous manner. The telemetry parser/interpreter program also optionally saves the received device telemetry data to a database instance of the system database (2060).

If the information received and interpreted is classified as behaving anomalously, the telemetry parser/interpreter program records the anomalous information in a system database and communicates the classification information and the received data to one or more attack classification programs for further classification. If the attack classification program(s) determine that the anomalous behavior is the result of an attack, the telemetry parser/interpreter program, coordinates the execution of other programs on the PES that determine the changes to be made to detect and remediate the attack, and to communicate those changes to affected devices. Note that multiple devices of the same class or manufacture, or running the same control software, may be affected by a discovered attack. The detection and remediation approach distributes the discovered changes to all affected protected devices, where the changes are downloaded and implemented as described herein.

### 6.2.2.1.7 Machine Learning Training Program (2120)

Trains and retrains ML models using input data include new and historical telemetry data. After training (or retraining), the trained ML models are saved in a system database (2060) for subsequent use.

### 6.2.2.1.8 ML-Enabled Program (2180)

A program configured with a ML model execution program (2188a) and/or expert systems program (2189) to enable use of ML techniques to generate program outputs. Includes ML versions of attack classification program (2125), specification management program (2130), and telemetry parser/interpreter program (2110).

### 6.2.2.1.9 ML Training Data Preparation Program (2182)

Performs operations to process and format input data to generate ML training data that can be used to train ML models.

### 6.2.2.1.10 ML Model Validation Program (2186)

Determines quality metrics associated with trained ML models, indicating accuracy of ML model output.

### 6.2.2.1.11 ML Model Execution Program (2188a, 2188b)

Loads and executes a trained ML model against ML model input data specific to the model to generate ML model output data. For example, the trained ML model may be used during attack classification and expert systems processing of attack reports.

### 6.2.2.1.12 Expert System Program (2189)

The expert system program uses one or more rules to classify input data, including information returned via telemetry, events, and exception data to recognize events or conditions that are considered anomalous. Classification is based upon matching of the input data against the one or more rules and/or exploitation fingerprints stored in a database or directly embedded within the expert system program.

In some implementations, the expert system program is implemented as a set of discrete programs, each focusing on one expert system aspects. In other implementations, the expert system program may embody a rules engine optimized for testing running program states and/or events against one or more rules, such as a rules engine implemented using the CLIPS expert system program and rules language.

In other implementations, the expert system program processes input data using expert systems methods such as complex events processing (CEP) to generate expert systems output data. The expert systems program retrieves data processing rules from a ML model output database (2060g), retrieves input data from one or more databases (e.g., databases 2060h, 2060b), and uses the rules to process the input data. In an example implementation, the expert systems program performs complex event processing (CEP) using the retrieved rules to recognize events and patterns. The expert system program is configured to generate alerts and otherwise communicate results generated by the program to other system processes.

In some implementations, the rules may take the form of an exploitation fingerprint, which comprises one or indications that an attack of a specific type has occurred (or even that a specific attack has occurred). The exploitation fingerprints are stored in a database with the other classification and expert systems rules.

### 6.2.2.1.13 Attack Classification Program (2125)

The attack classification program classifies received telemetry data and alerts (by the telemetry parser/interpreter program). In some implementations, the attack classification program is implemented as a set of discrete programs, each focusing upon a specific attack or class of attacks. The attack classification program may use one or more trained machine learning models to aid in the classification steps.

The PES can optionally use trained machine learning (ML) models (2112) trained on telemetry data by a ML training apparatus or program (2120) to assist one or more attack classification programs in classification of the received anomalous data as to whether the anomalous data represents an external attack, and if so, the type of external attack. These trained ML models are used to refine the system's ability to recognize and classify external attacks.

### 6.2.2.1.14 Specification Manager Program (2130)

The control specification manager program manages (creates, updates, and delivers) control specifications for protected devices operating one or more specific protected programs.

### 6.2.2.1.15 Program Inspection Program (2140)

The program inspection program receives program elements (or executables) and inspects them to determine if they are already modified, are required to be modified, and are able to be modified to integrate them with one or more protected program element modules that are effective to detect, monitor, and/or report malicious attacks against a protected device. There may be a plurality of program inspection program(s) supported, each providing a different static or dynamic code analysis technique. The inspection process is described in more detail below.

### 6.2.2.1.16 Program Element Modification Program (2150)

The program element modification program receives program elements (or executables) and modifies them to integrate them with one or more protected program elements, protected program modules, or protected program executables that are effective to detect, monitor, and/or report malicious attacks and operational anomalies, producing a protected program element and/or a protected program. The modification process is described in more detail below.

### 6.2.2.1.17 Protected Program Element Delivery Program (2160)

The protected program element delivery program publishes and makes available protected program element(s) and/or protected program(s) modified by the program element modification program. The publishing step includes writing the protected program element(s) and/or protected program(s) to one or more database(s) and making those items available using the user interface and/or a delivery protocol. For example, the protected program element delivery program may write a protected program element as a BLOB entry in a database, and then add index values to identify the protected program element to one or more delivery protocols. In an alternative example, the protected program element delivery program may write a protected program element, module, or program to a file on a local or shared disk, and then permission the file so it may be read by other programs. The protected program element delivery program may also provide protocol handling features that permit the written protected program element to be obtained using one or more well-known network protocols, or via the user interface. For example, a protected program element, module, or program may be downloaded using one or more of the following networking protocols: FTP/SFTP, NFS/CFIS, HTTP/HTTPS, RESTful API (over HTTP/HTTPS), BOOTP/TFTP.

### 6.2.2.1.18 Device Registration Program (2165)

The device registration program receives device registration requests over a network from unprotected and protected devices and processes these requests. The device registration program then responds to the request as determined by entries in the device registration database.

In some implementations, device identification information is provided as part of the registration request. In others, device identification information is provided by the device as part of the network protocol used to transmit the request. The device ID information is looked up in a device registration database, from which it is determined whether the device has been previously identified and protected. If the device has been previously identified and protected, the device registration program sends the device any required updates to its protected program(s) and/or control specifications.

### 6.2.2.1.19 Machine Learning Programs

As depicted in FIG. 5, an exemplary implementation of a PES (2005) is configured to perform at least some adverse event detection and remediation using one or more trained machine learning (ML) models and is further configured to train and retrain to one or more ML models. Referring to FIGS. 4 and 5, the PES (2005) includes components of PES (2000) although some are omitted from FIG. 5 for clarity.

In this exemplary implementation, the PES (2005) includes one or more ML-enabled programs (2180), each of which includes one or more of machine learning model execution program (2188a) and expert systems program (2189). ML-enabled programs (2180) include, for example, individual instances of telemetry parser/interpreter program (2110), attack classification program (2125), and/or specification management program (2130), each configured to use ML techniques to perform at least some of their prescribed functions.

In some implementations, the PES (2005) operates a ML model execution program (2188b) independently from operation, by a ML-enabled programs (2180), of ML model execution programs (2188a).

The machine learning execution programs (2188a, 2188b) execute a trained machine learning model using ML model input data to generate ML model output data (e.g., predictions, estimates, or forecasts). ML model input data includes, for example, telemetry data, including telemetry data that has been formatted or otherwise pre-processed for ingestion by the ML model, metadata and other external data, for example from non-IT asset data sources.

In an exemplary implementation, a ML-enabled program (2180) queries a ML model database (2060d), model validation database (2060f), and/or an independent model registry (not shown) for one or more trained ML model(s) and any parameterizing hyperparameters, and loads the selected models and their hyperparameters into the ML model execution program (2188a). In a similar manner, the PES (2005) retrieves, and loads into ML model execution program (2188b), a trained ML model and related information.

The PES receives and processes machine learning model input data from a data source such as a telemetry database (2060b), directly from telemetry parser/interpreter program (2010) and/or one or more additional data sources, for example from external database (2070), and then uses the input data to train machine learning models and to perform data generation executions of machine learning models.

In a first exemplary implementation, ML-enabled program (2180) includes attack classification program (2125) configured with an instance of ML execution program (2188a). The attack classification program controls the ML model execution program to retrieve, from ML model database (2060d), and execute a ML model that has been trained to recognize and determine a type of attack, or non-attack activity, based on received telemetry data. In an implementation, the ML model is trained, and can be retrained, using historical telemetry data that was received during a historical classified attack.

The attack classification program receives, from ML input database (2060h), telemetry data that has been processed for ingestion into the ML model. Alternatively, or additionally, in example implementations the attack classification program can receive telemetry data directly from the telemetry database (2060b) and/or from the telemetry parser/interpreter program (2110). The trained ML model processes the telemetry data to determine if the data indicates one or more types of attacks and generates output data that includes an identification of a type of attack or other non-attack activity.

In a second exemplary implementation, ML-enabled program (2180) includes an instance of attack classification program (2125) configured with expert systems program (2189). The expert systems program receives one or more rules, for example one or more attack signature rules, from ML output database (2060g) and uses the rules to process telemetry data to generate an attack classification. PES (2005) operates ML model execution program (2188b) to retrieve a ML model trained on telemetry data corresponding to one or more attacks. The ML model execution program executes the trained ML model to generate and update rules, for example attack signatures, and stores them in the ML output database (2060g).

Similarly, a telemetry parser/interpreter program (2110), configured as a ML-enabled program, can implement a trained ML model and/or expert system to identify execution exceptions based on received telemetry data.

In a third exemplary implementation, ML-enabled program (2180) includes specification management program (2130) configured with an instance of ML execution program (2188a). The attack classification program controls the ML model execution program to retrieve, from ML model database (2060d), and to execute a ML model that has been trained to select remediation, to generate one or more control specification changes, based on a classification of an attack generated by the PES, for example by an attack classification generated by the attack classification program (2125) and/or based on telemetry data.

The specification management program receives one or more attack classifications from the attack classification program and/or telemetry data from one or more of the ML input data store (2060h), the telemetry database (2060b), and the telemetry parser/interpreter program (2110). The trained ML model processes the attack classification and/or telemetry data to determine one or more control specification changes.

Additional aspects of the PES (2005) are programs that train, validate, update, and store the machine learning models that are used by the ML program. ML training data preparation program (2182) performs operations to process and format input data to generate ML training data that can be used to train ML models. ML training program (2120) uses the ML training data to train ML models, thereby generating trained ML models (2112). The ML training program re-trains or updates the training of ML models as the system collects additional data and produces additional estimates, predictions, and forecasts. ML model validation program (2186) performs validation testing on trained ML models to generate one or more metrics that can indicate accuracy of predictions generated by the trained models.

The machine learning (ML) training data preparation program (2182) retrieves input data from one or more of the input data sources and/or databases (e.g., telemetry database 2060b). The ML training data preparation program processes the retrieved data to generate machine learning model training, validation, and testing data formatted as a data frame suitable for use in training one or more ML models. Processing of the retrieved data includes cleaning the data to remove outliers, interpolating or otherwise filling in missing data points, and removing erroneous or otherwise unneeded data and formatting the data in a data frame. In some implementations, one or more of these data cleaning operations are carried out by telemetry parser/interpreter program (2110) prior to the data being written to a database. In other implementations, the data cleaning operations are carried out after the data has been written to a database. The ML training data preparation program (2182) generates and pushes, or otherwise makes available, filters usable by the telemetry parser/interpreter program to perform data cleaning and formatting operations. The ML training data preparation program generates training data useful for initial training of a machine learning model and training data useful for retraining or updating a previously trained machine learning model. The ML training data preparation program stores ML training, testing, and validation data in ML training database (2060e).

In an implementation, the ML model database (2060d) includes algorithms from commercially available ML toolkits (either internally to the dynamic application, or by reference to one or more external programs) as well as custom algorithms and models. Some examples of types of predictive models include (without limitation) regression models (e.g., linear regression, logistic regression), neural network models parameterized by one or more hyperparameters, classification and regression tree models, multivariate adaptive regression spline models and other machine learning models (e.g., Naive Bayes, k-nearest neighbors, Support Vector Machines, Perceptron).

The ML training program (2120) retrieves an untrained, partially trained, or previously trained ML model from the ML model database (2060d), retrieves ML training data from the ML training database (2060e), and uses the training data to train or retrain the ML model, thereby generating a locally trained ML model (2112), which it then stores in a database, e.g., the ML model database (2060d) or a model registry.

The ML training program also operates to directly retrieve newly collected data corresponding to features of a trained or untrained ML model from a database, and the ML training program uses this newly collected data to incrementally improve the training of a trained model as the newly collected data becomes available. The re-trained or updated ML model is stored in the ML model database.

The ML model validation program (2186) retrieves a trained ML model (2112) from a database (e.g., the ML model database (2060d)), retrieves evaluation data (i.e., testing and validation data) from the ML training data database (2060e), and performs testing and validation operations using the trained model and the retrieved testing and validation data. The ML validation program then generates a quality metric, e.g., a model accuracy or performance metric such as variance, mean standard error, receiver operating characteristic (ROC) curve, or precision-recall (PR) curve, associated with the trained ML model. The ML model validation model generates the quality metric by executing the model and comparing predictions generated by the model to observed outcomes. The ML model validation program stores model quality metrics in a database (e.g., the ML model validation database (2060f), or the ML model database (2060d)) associated with the trained ML model.

The ML model validation program periodically tests trained ML models using training data derived from collected telemetry data and recalculates the quality metrics associated with each of the trained ML models. Trained ML models are retrained by the ML training program (2120) if the system determines that associated quality metrics have deteriorated below a threshold amount. Trained ML models are also retrained on a periodic schedule. After retraining, the updated metric scores are ranked and used to determine and select the “optimum” trained model for each set of data values, and the association between the set of data values and the selected trained model is stored in a database. Updated hyperparameter data sets are similarly extracted from the selected trained model and are stored in a database.

In some exemplary implementations, the PES further comprises an optional expert systems program (2189) that processes input data using expert systems methods such as complex events processing (CEP) to generate expert systems output data. The expert systems program retrieves data processing rules from a ML output database (2060g) or from model database (2060), retrieves input data from one or more databases (e.g., databases 2060b or 2060h), and uses the rules to process the input data. In an example implementation, the expert systems program performs complex event processing (CEP) using the retrieved rules to recognize events and patterns. The expert system program is configured to generate alerts and otherwise communicate results generated by the program to other system processes.

### DHCP/BOOTP Service

In an example implementation, the communications subsystem may provide a DHCP/BOOTP service and related file download service as described below.

A PES may provide an optional custom DHCP/BOOTP service for providing protected program executable boot images to protected devices. DHCP/BOOTP are well-known TCP/IP protocols that provide IP addresses, network and device configuration parameters, and optional boot image references to clients requesting network access. Typical DHCP/BOOTP services provide a flat file database of networks, clients and their network configurations, and network address assignments. The custom DHCP/BOOTP service provides the above, and additionally may provide security reporting/logging server addresses, protected boot images, and protection configuration information.

The protected device database instance of the system database may be interfaced with a customized DHCP/BOOTP service provided by the communications subsystem, where the DHCP/BOOTP service uses information in the protected device database to determine the parameters returned to the protected device when it is booted and/or requests a network address. The DHCP/BOOTP service may update fields in the protected device database, including the last boot/reboot time.

Upon receipt of a DHCP or BOOTP request, the DHCP/BOOTP service may respond in various ways based upon the type of request and the status of the requesting device.

For example, the DHCP/BOOTP service may respond to a DHCP or BOOTP request from a known protected device with a DHCP response including a reference to a protected program executable stored in the system database, and optionally may include protected device configuration parameters as specified in the protected device database. The device may be further assigned a network ID that indicates the device is known and protected. The last boot/reboot time may be set by the DHCP/BOOTP service to the time of the DHCP/BOOTP request.

In an alternative example, the DHCP/BOOTP service may respond to a DHCP or BOOTP request from an unknown or known unprotected device by creating an entry in the protected device database and downloading a known protected executable and configuration for a protected device of the same type (where the device ID/type of the requesting device is known). The device may be further assigned a network ID that indicates the device is known and protected. The now protected device may be managed normally.

In another alternative example, the DHCP/BOOTP service may respond to a DCHP or BOOTP request from an unknown or known unprotected device by creating an entry in the protected device database and identifying the device as an unknown type requiring protection. In some cases, the device is further assigned a network ID that indicates that the device is unknown or not protected.

### Example File Download Service

A PES may provide a file download service, as either an option to the user interface, and/or by providing services that respond to standard internet protocols such as TFTP and FTP (and their secure versions). The file download service provides for downloading protected boot images (as referenced by the above DHCP/BOOTP service), protected executable files, and protected configuration parameter information as defined in the protected device database (or other data store) comprising protected boot images, protected executable files, and/or protected configuration parameter information. For example, the file download service may respond to requests for a boot image with one or more instances of a protected program, a protected version of a DLL, shared library, a portable executable (PE) (Microsoft Windows) executable, or COFF or ELF formatted executable. Other types of file downloads are also envisioned.

Upon receipt of a request for a download, the file download service validates the requestor as an authorized client (either by checking the provided credentials or certificate, depending upon protocol) or by validating the requestors network address against the protected device database and/or the DHCP/BOOTP databases described above.

### 6.2.2.2 Protected Devices

Protected devices are network-connected devices that operate under the control of at least one protected executable, typically provided by and in communication with a PES. There are two classes of protected devices, based upon the complexity of the device hardware and its capabilities. The first class has a single monolithic executable which functions as the device control, interface to the PES, and performs the functions of the network device. It does not have an independent operating system. In some implementations, the protected program is downloaded into the device using a program loader. It is a single purpose executable, such as an executable that periodically reads a temperature sensor and makes the sensed temperature available to other network connected devices. A second class of protected device is more complex, and includes an embedded multitasking operating system (e.g., Embedded Linux), that executes one more independent executable program(s). Some or all of the independent program executables may be protected program executables. Examples of this class of device include a network connected telephone such as a VOIP telephone, or a router.

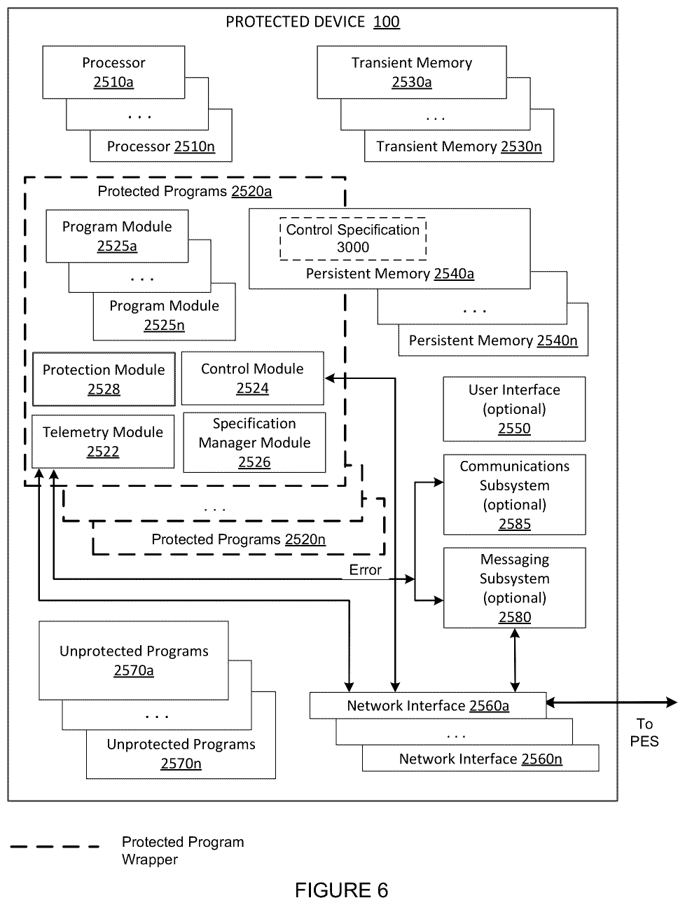

FIG. 6 depicts an example protected device (e.g., device 100) that embodies the described technologies. A protected device according to the technology disclosed herein configures and operates network devices that include a) a monolithic protected executable, or b) a multitasking operating system (OS) and a plurality of protected executables. The persisted protection system operates in various ways to achieve the desired persistence of protection. The system sets up persisted protection for a monolithic executable device by intercepting a processor at well-defined points during execution and setting up a “wrapper” to modify an executable by inserting new material (called protected program elements and protected program modules). The persisted protection system then releases the device processor so it may perform its original function and the processor control is returned to the persisted protection when a protected program element is executed.

In a multitasking OS network device, the system adds additional application programs to communicate with a messaging or communications subsystem (e.g., 2580, 2585). The persisted protection system for multitasking OSs further sets up additional programs on the network device to communicate with a PES in order to receive control instructions and control specifications. For example, the system sets up a telemetry messaging program (a program that implements a stand-alone program version of the telemetry module 2522) on the network device in order to communicate telemetry data to one or more PES via a messaging subsystem (2580) or a communications subsystem (2585), and a control specification manager program (e.g., a standalone program implementation of the specification manager module 2526 and the control module 2524) in order to receive control specification(s), control specification updates, and control instructions from one or more PES.

The protected device includes one or more processors (2510a, . . . , 2510n), typically either general purpose CPUs (e.g., Intel, ARM) and/or specialized processors such as an FPGA, GPU, ASIC, etc.), operably connected to data storage comprising persistent (2540a, . . . , 2540n) and/or transient (2530a, . . . , 2530n) memories. In some implementations, the processor component may include additional security features such as curtained execution and protected processing modes that are accessed by protected programs in order to increase the protection provided by the protected programs.

Persistent memories (2540a, . . . , 2540n) can include disk, PROM, EEPROM, flash storage, and other technologies characterized by their ability to retain their contents between on/off power cycling of the network connected device. Some persistent memories can take the form of a file system for the network connected device. These persistent memories, in the form of file systems, can be used to store control and operating programs and information that defines the manner in which the protected device operates, including scheduling of background and foreground processes, as well as periodically performed, or event-driven processes. Control specification(s) (3000) specifying the protections and protected operation of the device are optionally stored in the persistent memories. Persistent memories in the form of network attached storage (storage that is accessible over a network interface) also can be used without departing from the scope of the disclosure.

Transient memories (2530a, . . . , 2530n) can include RAM and related technologies characterized by the contents of the storage not being retained between on/off power cycling of the network connected device.

The data storage is useful to store information being processed by the protected device and/or to store various program instructions (collectively protected programs 2520a, . . . , 2520n, and unprotected programs 2570a, . . . , 2570n). Each of the protected program executables can be loaded and executed by the processor(s) in order to perform their intended operations and additionally perform the specialty execution time protections as described herein. The one or more processors are further operably connected to networking and communications interfaces (2560a, . . . , 2560n) appropriate to the deployed configuration.

Network interfaces (2560) are operated under control of the processor and the processing instructions contained within the control and operating programs mentioned above. These interfaces provide a connection to wired and wireless networking products (e.g., ethernet of various types, WiFi (802.11), Bluetooth, zigbee, ZWave, CANBus) that operably connect the network connected devices, data sources, PES servers, and network services described herein. For purposes of clarity, each network interface (2560a, . . . , 2560n) is illustrated as a separate interface, but can be implemented as one or more physical or virtual interfaces if desired. The network interface may connect to the first link of a chained or mesh network, such as a Bluetooth connection to a router, mesh device, or cell phone functionally acting as a router, and wireless or broadband connections from the functional router to a LAN or WAN. In addition, the network connection may provide intermittent connectivity.

Table 3 lists the common programs and modules found on a protected device.

TABLE 3

| PROGRAM | DESCRIPTION |
|---|---|
| User Interface | The User Interface program permits the user to receive |
| (2550) | protected device status, receive alerts related to protected |
| | devices, and enter device protection and control strategies |
| | and instructions for implementation by the PES. |
| Messaging | Optional module using messaging systems (not shown for |
| subsystem | clarity) for communication with other network connected |
| (2580) | devices and PES, typically used to send messages and/or |
| | telemetry data from a protected device to other devices on |
| | the network including one or more PES, and to receive |
| | messages, instructions, and control specifications from a |
| | PES. |
| Communications | The communications subsystem provides an alternative |
| Subsystem | mechanism for sending and receiving information to/from a |
| (2585) | protected device. The communications subsystem provides |
| | a common internet protocol (e.g., HTTP/JSON, FTP/TFTP, |
| | DHCP/BOOTP) interface to the protected devices and |
| | provides protected materials and instructions over these |
| | common protocols. |
| Unprotected programs | Executable programs not contained within a protected |
| (2570a, . . . , 2570n) | program wrapper (indicated by a dashed line in FIG. 6). |
| Protected programs | Executable programs comprising one or more application |
| (2520a, . . . , 2520n) | modules (program elements) and protected program |
| | modules (comprising one or more protected program |
| | elements). The modules of the protected programs are listed |
| | in Table 4. |

The protected device can have an optional user interface (2550), which can be local or remote. The user interface optionally connects to an onboard or external display, comprising one or more of an LCD panel, LEDs, a small OLED screen, or any other means of displaying information to the user. The user interface also optionally connects to control hardware or software comprising buttons, switches, dials, motion detectors, voice recognition detectors/programs, user input using a specific program (app), or similar. In some implementations, the user interface comprises a touch screen. In other implementations, the user interface comprises a web server interface. In yet other implementations, the user interface comprises a network-connected voice interface device such as a digital assistant or distributed UI device that uses voice input to communicate with cloud-based controllers or servers that then perform control functions.

The protected device also optionally provides a messaging subsystem (2580) which is a program that can be used to send messages and/or telemetry data from devices connected to the PES to other parts of the network. The messaging subsystem optionally can use an IoT message broker protocol such as RabbitMQ, EMQ X, MQDT, and VerneMQ. Devices on the network take telemetry data from protected elements and modules and report them to a PES. The reporting communications may be direct (device to PES) or indirect (device to intermediate device to PES).

The protected device also supports an optional communications subsystem (2585), which provides an alternative messaging method using common internet protocols. The communications subsystem provides protocol translation and communications with network connected devices in support of protected program modules as described below.

Unprotected programs (2570a, . . . , 2570n) are executable programs that have not been modified to provide one or more aspects of protection against malicious run-time attacks.

Protected programs (2520a, . . . , 2520n) are executable programs comprising protected and unprotected program modules. Unprotected program modules are unaltered protected program modules further comprising protected program elements which modify the operation of the protected program module to provide persisted protection against run-time attacks. A protected program comprises an application program, further comprising one or more program modules (both protected and unprotected). The protected program modules (collective protection modules) comprise one or more protected program elements, which modify the operation of the protected program in order to enforce one or more protections of the running protected programs. Protected programs and their modules are discussed in detail below.

Persisted protection is defined as an aspect of increased program protection that is present from one device restart to another. For example, telemetry collection that provides telemetry information obtained from prior execution, e.g., before a device reboots, would be considered a persisted protection.

The protected programs (2520a, . . . , 2520n) on protected network connected device (e.g., 100a) further comprise persisted telemetry, messaging, and communications aspects, which facilitate inter-process and inter-device messaging and notification via one or more messaging and alerting systems. These messaging and alerting systems can include operating system provided inter-process communication facilities (IPCs) and third-party messaging middleware subsystems such as MQ from IBM.

The described protected programs provide significant advantages over existing protection systems, ranging from persisted telemetry and providing a recoverable state for attacked devices, to providing dynamic updates without requiring the re-analysis and regeneration of a protected executable to change the operational characteristics and include/exclude/modify the protections.

The protected device optionally supports one or more programs and/or program modules (not shown for clarity) that provide management information useful to report on the operation of the network connected device. These programs provide device management information utilizing a web services interface or other dedicated management information reporting systems such as SNMP.

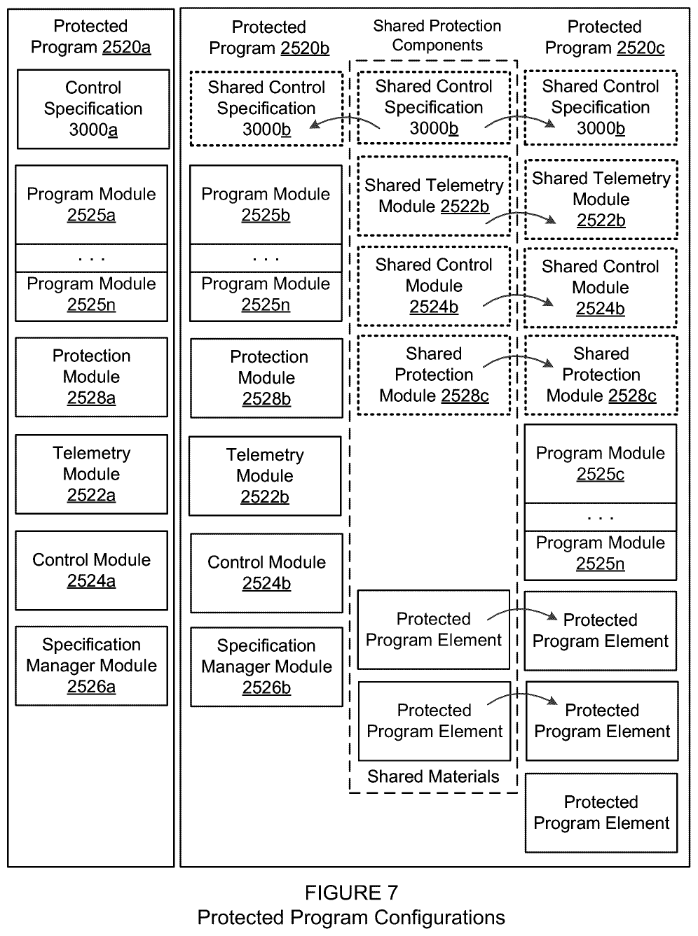

Table 4 lists the protected program modules that may be included in one or more of the protected program configurations of FIGS. 6 and 7.

TABLE 4

| MODULE | DESCRIPTION |
|---|---|
| Program modules | Unprotected program modules include the original |
| (2525a, . . . , 2525n) | unmodified program code. Protected program modules are |
| | the protection-modified modules identified by the PES as |
| | requiring protection as modified to incorporate the identified |
| | protections. |
| Telemetry | Collects telemetry data from a protected device, including |
| module (2522) | execution exceptions, and reports it to one or more PES. |
| Control | Controls one or more aspects of protected device operations |
| module (2524) | based on the control specification and in response to attacks |
| | and/or information received from a PES. |
| Specification | Receives and implements the control specification (3000), |
| manager | such as communicating changes/settings mandated by |
| module (2526) | control specification to other device components/modules |
| | and adding or modifying control specification(s) in the |
| | persistent memory. |
| | A control specification defines how a device operates to |
| | define, detect, identify, report, and respond to one or more |
| | detected anomalous behaviors. |
| Protection | Provides the logic for implementing one or more of the |
| Module (2528) | protection methods that are common to various |
| | implementations. Individual protection logic is provided as |
| | protection program elements. |

### 6.2.2.2.1 Program Modules (2525a, . . . , 2525n)

Program modules comprise a collection of unprotected and protected program modules. Unprotected program modules are program fragments identified by the PES as not requiring modification for protection. Protected program modules are those modules modified by the PES to include one or more program elements that provide the desired protections.

In this case, the terms “program module” or “protected module” or other types of module refers to a structural part of a program. While some short or simple programs may be written as a single piece of inline code, most programs include modular structures such as a main routine and one or more subroutines, functions and/or interrupt handlers each of which is a module. The main routine typically calls the subroutines or functions, in some cases passing them parameters. The subroutines or functions then execute to perform certain tasks, and when finished executing such tasks, return control to the main routine—often passing parameters back to the main routine. Similarly, an interrupt handler may interrupt or suspend execution of currently executing code to service a real time event such as receiving and processing inputs.

Thus, the terms “xxxx module” are not nonce terms having no structure associated with them, but rather, refer to particular structural software objects—namely software routines that are respectively structured to separate the functionality of a program into independent, modular routines each of which contains everything necessary to execute one or a small number of aspects of the desired overall functionality, and which enable the overall functionality of the program to be separated into subfunctions that manage their own data to thereby reduce complexity and code dependence. See e.g., Westra, “Modular Programming with Python” (Packt Publishing 2016); Seydnejad, Modular Programming with JavaScript( Packt Publishing 2016); White, “Making Embedded Systems: Design Patterns for Great Software” (O'Reilly 2012); Cook, S, “Languages and Object-Oriented Programming,” Software Engineering Journal, pp. 73-80 (March, 1986); Goldberg, A. et al, Smalltalk-80: The Language and its Implementation (Addison-Wesley, 1983); Ramamoorthy, C. V. et al, “Object-Oriented Systems,” IEEE Expert, pp. 9-15 (Fall 1988).

### 6.2.2.2.2 Telemetry Module (2522)

The telemetry module collects telemetry data from the protected device, including execution exceptions, and reports it to the PES (2000) over the network using the network interface (3100) or the messaging subsystem (3090).

### 6.2.2.2.3 Control Module (2524)

The control module allows the system to maintain control of the protected device after the device has been attacked and the attack is successfully intercepted. Examples of actions that a control module may perform include one or more of the following: halting the program, bricking the device, generating an alert, changing reporting requirements/specifications, failing to safe (recovery) mode, and ignoring the reporting. For example, if a decision is made to stop execution of the active program, program control is passed to the control executable, which terminates the program operation, and optionally places the device into safe mode from which it can be programmatically restarted and/or have its control information updated.

### 6.2.2.2.4 Specification Handler Module (2526)

The specification handler module receives and implements the control specification, such as communicating changes/settings mandated by the control specification to other device components/modules and adding or modifying control specification(s) (3045) in the persistent memory.

### 6.2.2.2.5 Shared Modules

Depending upon the architecture of the protected device and its operating capabilities, the functionality of common protection elements may be implemented outside of the individual protected programs and provided as separate programs within the device. Specific common/shared modules related to providing persisted protection are described in detail below and includes shared protection modules like the persisted telemetry module (2522), the control module (2524), and the specification handler module (2526), as well as shared protection modules for protection against specific attacks. One advantage to using shared protection modules is that they may be updated once, downloaded to a protected device, and the changes are automatically propagated to all protected programs that share them.

For example, a standardized replacement function preamble program element may be provided within a protection module that implements enable/disable functionality for a specific protection function. If a protection is disabled in the control specification, the program element bypasses the setup and testing of the specific disabled specification. Similarly, if a specific protection is enabled, the program element calls the setup and testing associated with the enabled protection function. In this way, multiple protection functions may be installed within a protected program, and each may be selectively enabled or disabled as needs dictate. This reduces the runtime overhead of having a protected program instrumented for many different protection functions when only one is required at the current time.

In a second example, a standard replacement function suffix program element may be included in the shared protection module which provides similar functions on program exit.

In a third example, the actual protection code may be included in a shared protection module. This provides increased updatability of protected programs in case of program logic errors (e.g., bugs) and/or the creation of new or enhanced protection logic.

### 6.2.2.2.6 Protection Module (2528)

The protection module provides the logic for implementing one or more of the protection methods that are common to various implementations and may be called from a protected program to fully initialize protection methods implemented as protection program elements specified for a protected program by the then current control specification. One or more protection module(s) can be added at link time (or before) to a protected program, or it can be added post-link time as the protected program is invoked for execution. Protection modules may implement specific types of protection as individual protected program elements as described in Table 5 (for statically linked protected programs) or implement a dynamic loader function that loads a shared library (or similar structure) of protected program elements and implements the integration of these protected program elements into the running executable program.

A flavor of protection module is a protected program element that adds the capability of dynamic loading specific protected program elements to a running protected program so that they are executed during program execution.

In typical linker-based usage (e.g., static protection model), the protected program elements are linked into the application program and are called during the normal course of program execution. This represents a static protection scheme and requires relinking of the application program if the protected program elements are required to protect the program change.

In an alternative implementation, the “protections loader” program element is linked into the application program, and is called by the running program, preferably before any application program code is executed. For example, the loader program module may be configured so it is called instead of the main( ) procedure of a C program. The loader program element then calls the application program's main( ) procedure when the protections are installed and configured. The protections loader program element loads one or more dynamic loadable library(ies) comprising one or more additional protected program elements within a memory space associated with the currently running program and modifies the run time call sequences of the running program to redirect program calls to the shared library to the appropriate protected program elements. Typically, this is accomplished by redirecting the linkage to original shared libraries (such as links to functions in libc for the C-based example given above, lua.so for the Lua language-based applications on a Linux platform, etc.). For other languages, the protections loader may identify the linkages identified in the global symbol table/global offset tables of an ELF formatted executable (or the equivalent structures in other executable file formats), and implement linkage changes by changing the global symbol/global offset/procedure linkage table for the running program. The global symbol/global offset/procedure linkage table is known by different names depending upon the executable file format and/or the operating system it is targeted for; functionally it contains linkage symbols for position independent loading of the program and runtime linkage to/from related to shared library usage. The advantage of this implementation technique is that the dynamic library may be replaced without changing the base protected program so protected program elements may be changed “on the fly” by changing the shared library of protected program elements. This capability is also used in the dynamic protection program described below.

### 6.2.2.3 Protected Program Configurations

FIG. 7 depicts an illustrative schematic layout of various common protected program configurations of protected programs showing how a control specification and protected program modules may be integrated to produce dynamically updatable protected programs. The first example configuration is a monolithic protected program that incorporates all the protections and control information into a single (static) protected program executable (e.g., protected program 2520a). The control specification (3000a) is embedded in the protected program 2520a at the time the protected program is assembled, and changes require the provision of a new protected program.

The second example protected program configuration utilizes a monolithic executable architecture (e.g., protected program 2520b) with an updatable control specification, which enables the operation of the protected program using updatable control information. Protected programs 2520b is constructed differently than 2520a, with the control specification being updatable and potentially shared between a plurality of protected programs. Updating the control information permits the operation of the program protections to be customized and updated as new attacks and threats that utilize common attack vectors are identified, and the operation of the device with updated control specifications require only downloading the new control specification. In this example implementation, the control element can be a data structure stored with the protected programs, a shared library stored in the protected device along with the protected programs that comprises the control specification, or another shared data structure stored in a persisted memory of the protected device within which the protected programs are installed. The use of a shared library permits protected program to utilize techniques such as “on demand” reloading of the shared library after updated versions of the library are received by the protected device to apply updates without rebooting the device or restarting the protected program.

A third example protected program configuration (e.g., protected program 2520c) utilizes updatable shared protection modules (and associated protected program elements) and updatable control information. Protected program 2520c is constructed differently than either 2520a or 2520b, although it comprises the shared control specification as described above. Protected program 2520c further utilizes shared (between protected programs) program modules and shared program elements. The shared program modules provide improved efficiency and smaller protected program executables and may be implemented in shared libraries or as stand-alone executable programs for protected device architectures that support multi-tasking. The shared program elements aspect of this configuration permits the dynamic changing and modification of the protection program elements themselves, including the dynamic enabling/disabling specific protection techniques on a module-by-module basis.

### Stand-Alone Dynamic Protection Program and Its Operation

In another alternative implementation, the protection module may be implemented as a separate stand-alone dynamic protection program that operates in its own application memory space and modifies applications programs when they are loaded and executed. This dynamic protection program is installed on the device to be protected.

The protection module of the protection program may intercept program loads by monitoring process creation call (e.g. monitoring or hooking the system exec( ) call on a Linux-based system), and upon detecting a newly created process, injects the control-specification specified protected program elements into the newly created process being loaded using the same techniques as the above described “protections loader”. This approach dynamically creates a protected program at load time. When the protection program intercepts the process creation calls on a system, the protection module redirection process may be repeated for each program (process) that is started on the protected device, with the modifications to include protected program elements into each loaded program occurring as each program is loaded for execution. Similar techniques are used for non-Linux based multi-tasking operating systems.

One method of making these modifications to the loaded program is to use a ptrace( )-like technique to attach an external protection program to the loaded program to be protected, allowing the protection program access to the loaded program's memory space. If the protection module already has access to the loaded program's memory space, it can directly load the shared programs into the loaded programs memory space. In an example implementation, the preloading technique can be accomplished on a Linux system using LD_PRELOAD feature of the operating system. Similar features are present in other operating systems.

The protection module/dynamic protection program then identifies one or more shared libraries to attach to the loaded program on the basis of shared libraries and symbols referenced by the loaded program. In a first approach, these libraries may be identified by processing the executable image to determine the symbols being provided by one or more shared library and using these symbols to identify the shared libraries to load. In an alternative approach, the names of the shared libraries are identified from the program executable file of the program to be protected. The identified shared library(ies) comprising protected program elements relevant to the loaded program are then loaded into memory and associated with the loaded program. The loaded program is then additionally modified to redirect one or more execution paths calling functions in the identified (original) shared library to functions in the newly added shared libraries. While the specific program modifications used are implementation dependent, they generally involve changing the references to a shared library function (e.g. printf( ) in libc for C-based program) to reference protected program elements, which provide the protections. The referenced protected program element(s) perform the protection function and then call the originally called function (e.g., printf( ), memcpy( ) in the libc library). The protection module provides the path to the original shared library to the protected program elements using an operating system dependent method. In a Linux-based system, the protection program may set the RPATH environment variable to the location of the original shared library prior to loading the protected program elements into memory so the Linux runtime handler for shared libraries can dispatch the call to the originally called function. This general technique provides a dynamic protection environment where the existing programs do not require recompilation and/or relinking to add or change the implemented protected program elements and provides only the protections identified in a control specification.

Similar techniques also may be used to protect operating system components of the protected device, including kernel modules and device drivers. In this example implementation, the operating system has one or more of its individual components implemented as protected programs. This approach has particular utility for service-based operating systems, where operating systems functions are provided as independent system services (e.g., Mach, some Linux-based implementations).

One advantage of a stand-alone protection program approach is that it is development language agnostic and can be implemented for executables post-link without regard or knowledge of their implementation language(s) the executable was implemented in. The protection module recognizes the shared libraries that these programs utilize, and it protects the functions in the shared library (which typically include most system calls and common utility functions). When protections are applied “in the field” by a standalone protection program/module, the protection program notifies the controlling PES of the program it protected, and the nature of the protections applied. If the stand-alone protection program cannot determine the applicable protections to apply, it reports the issue to its controlling PES, where new protection shared libraries can be created and specified for subsequent use.

In some operating systems, the stand-alone protection program may require privilege at SYSTEM_HIGH or have specific privileges and/or capabilities that permit it to attach to a process as a debugger. The stand-alone protection program may be implemented as a separate thread, task, or as a separate co-executable depending upon the capabilities of the underlying operating system. Whatever the operating system-dependent implementation approach, the function of the protection module remains the same: it loads and associates a dynamic library of protected program elements with an application and makes the necessary adjustments to the executing program so one or more of the added protection program elements are executed by the running program. In this implementation method, the protection module operates independently of the protected program.

In implementations utilizing multi-tasking operating environments such as embedded Linux and Linux-like operating systems that use the ELF binary format, the standalone protection program can be implemented by redirecting the global offset table of the ELF binary format to reference the newly included library(ies) as described above. Once control of the loaded program is established, the loaded program has the protected program elements associated with it, and the protection program makes modifications to the global offset table that redirect one or more application calls to the protected program elements in accordance with the control specification. The benefit of this injection technique includes a substantial reduction in call and program size overhead of each protected program, the removal of limitations in instrumenting all aspects of the protected program using protected elements (as described above), and the ability to add new or different protections each time a program is loaded in accordance with one or more control specifications.

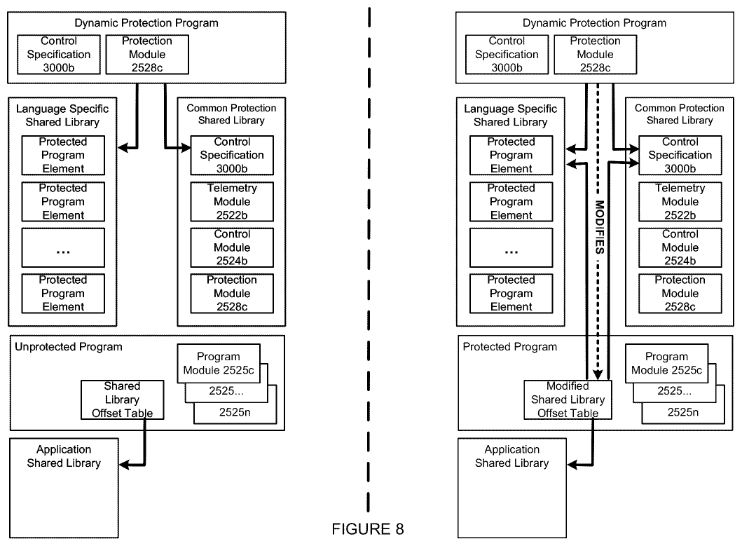

A particular example of protected program creation is illustrated in FIG. 8. In this example, an unprotected program is modified “on the fly” by a dynamic protection program that includes a protection module and may include functions such as a telemetry module and control specifications during modification. In this illustration, a before and after representation of the dynamically protected program is shown, with the resulting dynamically protected program having the protected program elements in shared libraries attached to it, and its global offset table modified to reflect the inclusion of these libraries.

Thus, the shared protection modules and protected program elements may be updated as needed to permit the operation of the program protections to be customized and updated as new attacks and threats, including attacks and threats that require additional protections or modified protected program elements, are identified. This configuration allows changes in the operation of the protection modules that require additional or changed program code. Updating only the shared portions means that the entire protected program does not need to be re-downloaded into the device; only the updated portions require re-downloading.

### 6.2.2.4 Functions of a Protected Device

A protected device can soft enable or disable specific protections based on one or more control specification(s). For example, a specification manager module (2526) of a protected device receives a control specification update from a PES and communicates any changes to specific protections to a control module (2524) which causes the protected device to implement the changes, for example enabling or disabling one or more protections as specified by the control specification, or by rebooting the protected device. In some implementation implementations a protected device receives control specification updates from a single PES. In other implementation implementations, the protected device receives control specification updates from more than one PES.

Protected devices collect and report telemetry data to one or more PES. A persisted telemetry module or subsystem (2522) collects telemetry data, including execution exceptions. Persisted telemetry differs from standard telemetry in that it supports the persistence of messaging/communications across protected device reboots and if the protected device was not originally designed to support telemetry functions. In some implementations, one or more control specification(s) received by the protected device from a PES specifies what telemetry data the telemetry program should collect. A telemetry module may use a messaging module (2580) to communicate the collected telemetry data to one or more PES, or it may use direct communications utilizing a communications module (2585). In a first implementation, a protected device performs reporting of telemetry data; for example, making telemetry data available to one or more PES. In some implementations, different telemetry data is provided to differing PES; for example, with one server receiving summary information, and a second server receiving detailed telemetry information. In a second implementation, a protected device maintains additional control over what telemetry data is reported and when it is reported. The telemetry program can digest received telemetry data and send, to one or more PES, summary(ies), with contents of the summary and timing of communication of summaries controlled by control specification.

In a first example implementation, the persisted telemetry module is implemented in a protected program that does not support telemetry. The telemetry module has messages queued for it from protected program elements and protected program modules that have been inserted into the protected program. These messages are inserted into a message queue, and optionally processed and transmitted to the PES by the telemetry module, and control is then returned to the protected program. In other implementations, the persisted telemetry module is associated with a clock-based event or interrupt that periodically dispatches processor control to the persisted telemetry module. The persisted telemetry module then processes any pending messages and returns control to the protected program.

In similar fashion, the persisted telemetry module checks for received messages when it receives processor either by call from a protected program element or via a time-based dispatch such as the above-described interrupt example.

Protected devices perform one or more defined actions in response to instructions received from a PES. In some implementations, instructions received from a PES describe one or more actions that a protected device should take autonomously in response to detecting a specific exception. Examples of actions that a protected device may take include one or more of the following: halting the program, bricking the device, generating an alert, changing reporting, failing to safe (recovery) mode, and ignoring the reporting. A more complete set of actions is defined below.

Lastly, protected devices act to detect and identify attacks against the device using a variety of protection techniques. Each protection technique to be used is provided as part of one or more protected program executables, which implement each of the protection schemes in accordance with the control specification(s).

In some implementations, when a protected device recognizes an exception it fails to a safe state, such as a recovery/compromised mode, from which the device may be remediated under control of a PES and brought back online. The recovery of the device is performed by the control module under the direction of instructions from a PES. One method of recovery of a device is to reboot it. A second method of device recovery is to reboot it and force it to load a new protected program from the PES during the device booting.

### 6.2.2.5 Control specification Data Structure

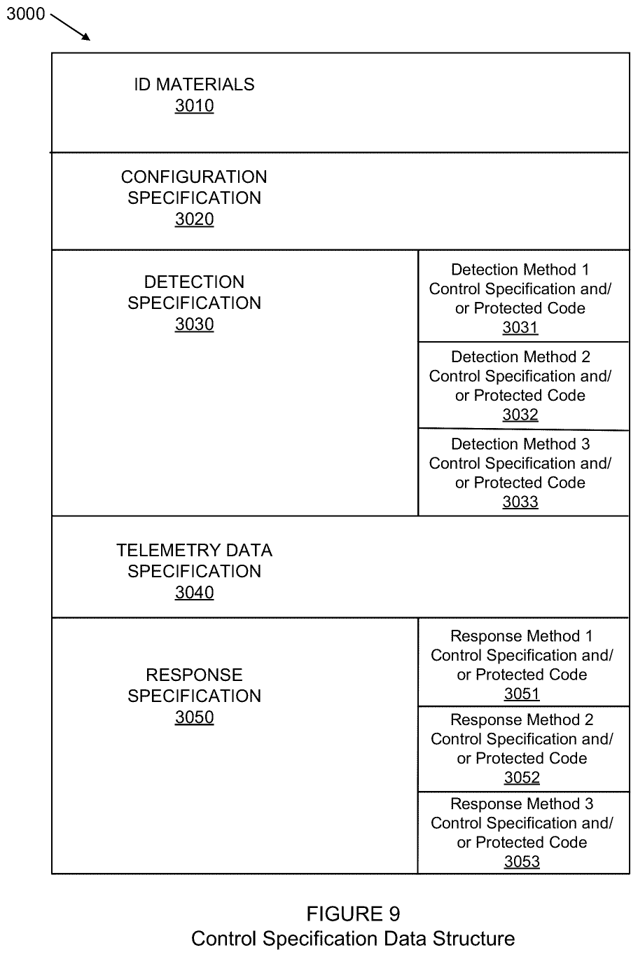

FIG. 9 illustrates an example of a control specification (3000) that provides control information to protected devices. Generally, it provides information to the protected device that defines one or more aspects of the device's operation such as the configuration of the detection program elements, specifications controlling how those detection program elements are to detect potential attacks, telemetry specifications (for endpoint definition and verification, what data to send, and how to send it), and response specifications which define how the protected device should respond to positive detections.

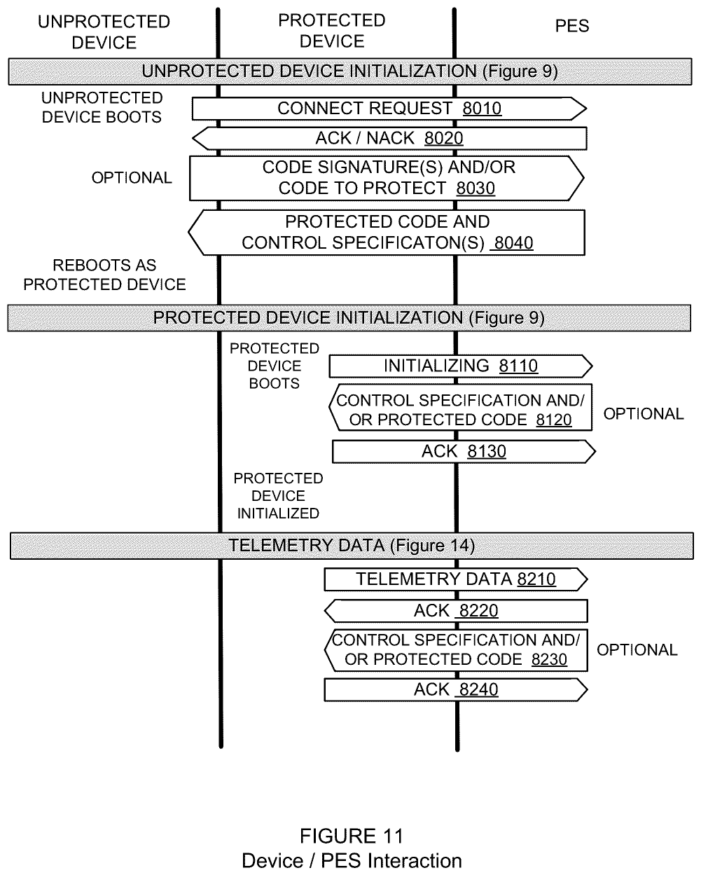

The control specification is typically implemented as one or more data structures. Each portion of the control specification may be implemented as part of a larger data structure or may be implemented as an independent data structure element or independent data structure. Control specifications may include other control specifications, either directly (e.g., embedded) or by reference. Each of these data structures and data structure elements are defined by a program of a PES and are provided to a protected device either a) as part of a protected program, b) as part of a protected program element to be included in a protected program, c) as one or more data structures encoded using a known data structure encoding (e.g., JSON, XML, binary encoding). The data structures and data structure elements provided may be downloaded by the protected device, pushed to the protected device by the PES, or provided as part of an updating protocol during protected device/PES interactions (as described below for FIGS. 11, 12, and 17). If a messaging subsystem is available, the data structures (and/or data structure elements) may be delivered using the messaging subsystem.

Returning to FIG. 9, the control specification comprises one or more identification (ID) material specifications (3010). ID material specifications provide information to the protected device that permits it to securely identify itself to a PES, and to securely identify a PES when connections are made over a network. For example, PKI elements and certificates may be included in ID material specification, so that a device may security identify itself by providing a known certificate to a receiver and may include signing information for one or more PES that permit the device to securely identify a PES it is connected to over a network. Identification materials for other identification schemes may also be included in the ID material specification.

The control specification further comprises one or more configuration specification(s) (3020), which are used by the protected device to configure its operation. In an aspect, the configuration specification identifies one or more PES that the protected device is to be in communication with, and the method of communication to be used. One or more communication methods may be specified, and if a plurality of communication methods is specified, a priority for method utilization may also be specified. For example, the communication methods specified may include whether to use the messaging subsystem or the communications subsystem for specific types of communications, and the protocol to be use in the communications. In another aspect, the configuration specification identifies the protection methods to be utilized by the protected device and specifies how the protection method should operate. The configuration specification may identify the protection methods supported for the protected program and provide operating parameters for each identified protection method as detection specifications. In addition, the configuration specification may provide enable/disable indications (on a detection method or function by function basis), supporting the selective enablement and disablement of specific protection methods. For example, a first protection method may be disabled, a second protection method may be enabled using a specific detection specification, and a third protection method may be enabled using a second detection specification. In this way, the protection operation of the protected device may be customized as needed, and in response to known and emerging attack threats known to the PES. In a third example, the configuration specification identifies one or more configurable aspects of the persisted telemetry module associated with the protected program. These aspects may include the communication parameters for a) PES endpoint for specific types of communication, b) communication method by communication type (e.g., messaging system vs. direct connection over a network, including protocol to use), c) telemetry data specification to use by communication type, and related information.

The control specification further comprises one or more detection specifications (3030), which define how the protected device detects potential attacks on a detection method by attack detection method basis. Each supported attack detection method is defined in its own specification element (e.g., elements 3031, 3032, and 3033). The number of supported elements will vary depending upon how the protected device is configured and which detection methods are incorporated into a protected executable.

The control specification further comprises one or more telemetry data specifications (3040), which define the formatting and content of telemetry messages sent between the protected device and a PES. This may include implementation-specific data formats, data elements related to the manufacturer of the device, data related to the network(s) that the device is connected to, and other device-specific information to be collected from the device.

The control specification further comprises one or more response specifications (3050), which define how the protected device responds to a positive or negative detected attack. For example, the defined response may be do nothing, or that the device should halt operation and await further instructions from the PES. Each type of detection method may have a separate specification that defines how the protected device should respond, as shown by the subsidiary response method specifications 3051, 3052, and 3053.

### 6.2.2.6 Telemetry Data Structure

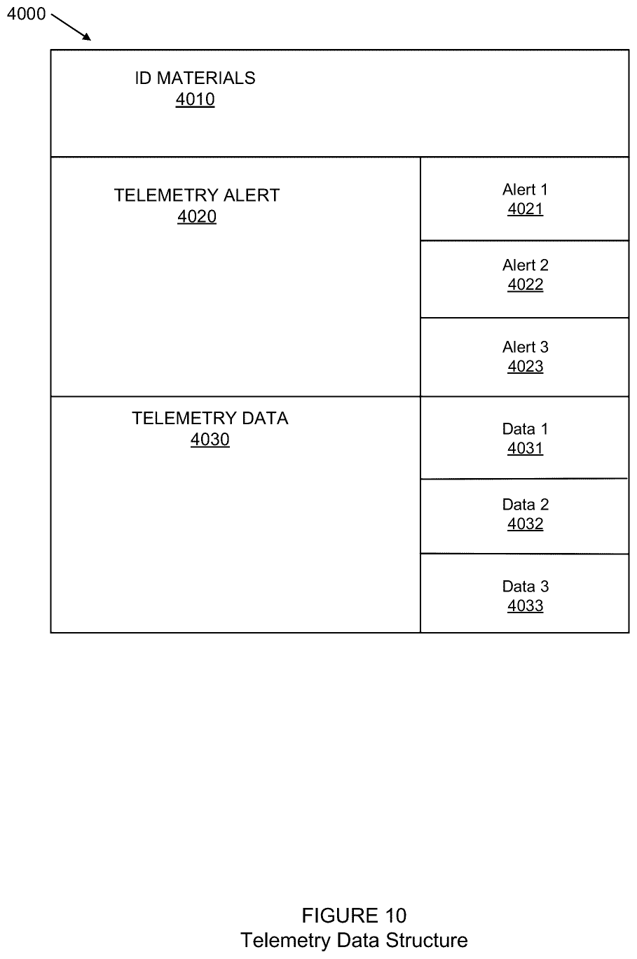

FIG. 10 illustrates an example logical data structure for telemetry data transmitted between a protected device and a PES. The logical data structure may be encoded using any known encoding scheme (e.g., JSON, packed binary) and may only include some of the sections identified in the example. Other additional sections may be included in the data structure.

The logical data structure comprises an identification section (4010), in which the sending device, and data particulars such as the sending device ID, date/time range for collected data, checksums for one or more of the sections, transmission sequence numbers, and the like are transmitted.

The logical data structure further comprises a telemetry alert section (4020), in which the sending device encodes and transmits one or more operational alert messages related to the operation of the protected device, and abnormalities detected by various aspects of the protected program. In this example, 3 alerts (labelled Alert 1 (4021), Alert 2 (4022), and Alert 3 (4023)) are depicted. Each alert encoding comprises information related the specific alert, such as the type of alert, the timestamp that the alert was generated, the alerting location in the protected executable, parameter values and data values that caused the alert, and the like. This section may be omitted if there are no alerts to be transmitted. The alert data is encoded in the format specified in a control specification.

The logical data structure still further comprises a telemetry data section (4030), in which the sending device encodes and transmits one more data elements related to the operation of the protected device. For example, the device may transmit data related to specific monitoring locations and the number of times that program execution has executed the protected code. Other information may be collected and transmitted as well. The data collected and transmitted, and the encoding format to be used are specified in a control specification. In this example, 3 data elements are depicted (labelled Data 1 (4031), Data 2 (4032), and Data 3 (4033)).

### 6.2.2.7 Interaction of the PES and Protected Devices

FIG. 11 illustrates exemplary network communications between a PES and one or more network devices.

The first flow illustrates an unprotected device contacting a PES to begin an interaction that results in the unprotected device becoming enrolled with the PES and receiving protection materials that permit it to operate as a protected device. Protection materials include control specifications and protected programs. In message 8010, the network device sends a connect request to a PES, which is then acknowledged by the PES in message 8020. The acknowledgement may request further information about the device, such as the version of the operating code, device attributes, and the like. The network device responds to this request in one or more message(s) 8030, to which the PES responds with protected code and/or control specifications in message 8040 for the device to utilize.

In a particular implementation, this interaction may be integrated into standard network protocols such as BOOTP and DHCP. In this implementation, the device makes a BOOTP/DHCP request (as its connect request 8010) that is responded to by the PES server with an extended ACK/NAK (8020) per the specific protocol. The PES server looks up the protected program to provide in the PES's database, along with other parameters that may be required. The response may include network parameters (e.g., IP address, Netmask, and gateway address) and may include a reference to a program to be downloaded and run by the device. The referenced program may be a protected program stored in the PES database, or a discovery program that further inspects the device and communicates details of the device in messages 8030 to the PES. The PES then responds with additional protection materials, e.g., control specifications and/or protected programs (8040).

The result of this interaction is that an unprotected device may be converted into a protected device and managed by the PES in accordance with the processes described herein.

The second flow illustrates an example protected device initialization, in which the protected device communicates with one or more PES indicating it is booting (or rebooting) and sends any delayed telemetry data from prior operations. These interactions are represented as message(s) 8110. The PES, recognizing the protected device, optionally sends any updated control specifications and/or protected code to the device in messages 8120. The protected device then acknowledges the interaction in message 8130.

A third flow illustrates an example protected device transmitting (on a periodic basis in accordance with a previously received control specification) one or more telemetry data elements to a PES as message(s) 8210. The PES acknowledges the receipt of the telemetry data (message 8220), and optionally sends any updated control specifications and/or protected code to the device in messages 8230. The protected device then acknowledges the interaction in message 8240.

### 6.3 Functions of the PES

The PES, as described above, supports the protection of network devices in several ways, including:
Registration of devices and assignment of device ID.
Creation and provision of control specifications.
Creation and provision of protected programs.
Receipt and analysis of device and sensor/attack telemetry.
Command and control of protected devices, including updating of protections as required.
Remediation control of attacked devices.

Aspects of each of these are described in the following sections.

### 6.3.1 Registration of Devices

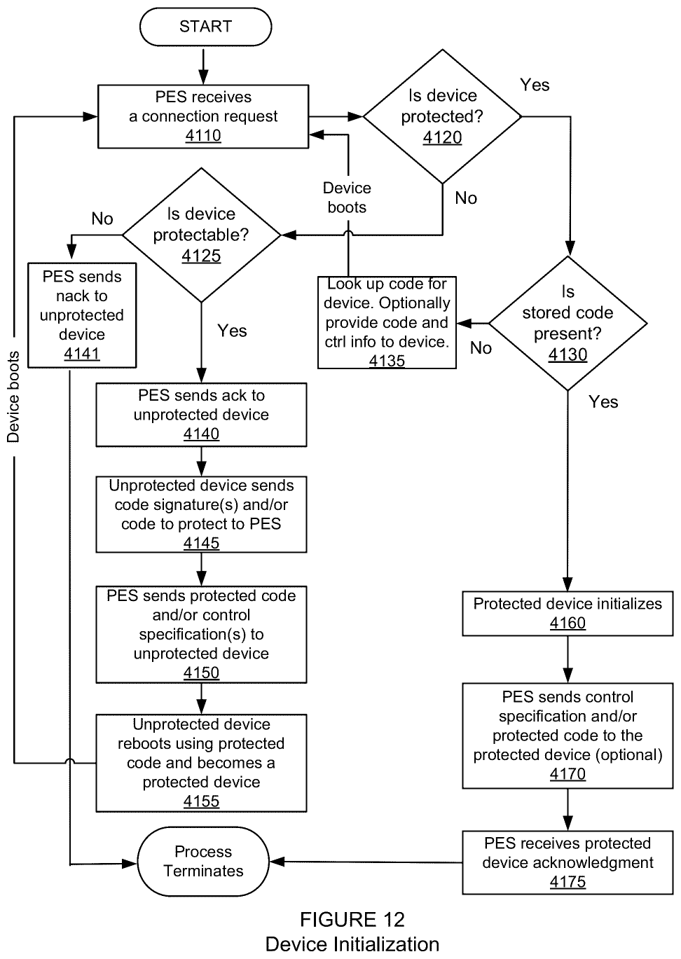

One aspect of PES operation is the identification and conversion of unprotected devices to incorporate device protection technologies, and to maintain the protections of previously protected devices in the face of new attacks against the devices. FIG. 12 illustrates an example process by which a PES automatically performs these operations. Devices also may be manually registered by a user.

The process starts when the PES receives a connection request from a network device as represented in FIG. 11 and at step 4110 of FIG. 12. The connection request may be a direct request over a network protocol such as HTTP, received from a messaging subsystem, or from a network protocol handler such as a BOOTP or DHCP server. Varying amounts of device information is provided with this request depending upon how the request is received, such as a MAC address, a device certificate (ID), device information, etc.

The PES then looks up the received information in a device database (2060a) (and/or cryptographically verifies it, for example, using a device certificate) and determines if the device has been previously registered with the PES. At step 4120, the PES determines whether the device is a previously protected device (e.g., a device that is already known to the PES and has been configured for protection) (yes branch to decision 4120) or if it is not protected and therefore needs to be registered and protected (no branch to decision 4120). If the device is not protected, the PES also determines, at step 4125, whether the device can be protected or not. As a result of these determinations, the process flow changes (steps 4140 and 4141).

If the device is not protectable (no branch to decision 4125), the PES sends a negative acknowledgement response to the device (step 4141) and terminates the process.

If the device is protectable (yes branch to decision 4125), the PES sends an acknowledgement to the device (step 4140). The acknowledgement may include additional discovery code that the device is to execute to provide additional information about the device. The device provides, and the PES receives, additional information from the device in step 4145, which is stored in one or more databases of the PES. The types of information may include firmware version information, device details including information about hardware configurations and device capabilities, device ID and/or name, and the like. If the device does not have a device ID assigned, the PES assigns a device ID to the device. In an implementation, the PES generates a device ID based on a unique device identity such as a Unique Device Identifier (UID) or Unique Device ID (UUID), or by using a unique device certificate issued to the device.

The PES then determines whether stored protected code and control specifications for the device (or type or class of device, as many unprotected devices are mass produced with specific programs on them) are available, and if so, this protected code and control specifications is provided to the device (over the network) in step 4150. If the protected code and/or control specifications are not available, the PES constructs new protected code (if code was provided by the device) and/or control specifications, stores them in a database, and then provides the newly constructed protected program(s) and control specification(s) to the device in step 4150. The device then reboots with the protected code and control specification in step 4155, making it a protected device, and the process restarts at step 4110 as the freshly rebooted device contacts the PES.

If the device is already known to the PES and protected, (yes branch from 4120), the PES determines if the protected device making contact requires protected code from which to boot (e.g., the BOOTP-type scenario). If so, the PES (No branch to 4130), looks up the device and the version of protected program and control specification required, and optionally provides a protected program (and control information) from which the device should boot in step 4135. The device then reboots as a protected device and the flow continues with step 4110 with the now protected device connecting again to the PES as a protected device.

After the device reboots on the newly provided protected code (or if the device has previously stored protected code and is booting from that code), the PES determines that the device is known and running protected code (steps 4120 and 4130), the protected device initializes and provides its device information to the PES (step 4160, part of messages flow 8110 in FIG. 11). The PES then looks up and determines if there are any required changes to the protected program(s) of the device, and/or change to the control specification applicable to the device, and if there are, the PES sends these changed programs and/or control specifications to the device (step 4170). The PES receives a receipt acknowledgement from the device in step 4175. The process of initializing devices then terminates.

### 6.3.2 Monitoring and Management of Protected Devices

The monitoring and management of protected devices comprises the following processes:
Creation and provision of control specifications.
Creation and provision of protected programs.
Receipt and analysis of device telemetry.
Command and control of protected devices, including updating of protections as required.
Remediation control of attacked devices.

### 6.3.2.1 Creation and Provision of Control Specification

The described above, the control specifications provide a mechanism for the PES to dynamically provide, and the device to implement, control information including telemetry specifications, alerting specifications, and device protection configuration information including information about what attack indicia should be watched for by the protected program elements inserted into the protected program.

### 6.3.2.2 Creation and Provision of Protected Programs

A function of the PES is to create protected materials (control specifications and protected programs, including protected program elements, protected program modules, and complete protected programs. A protected program may use standard protected program elements (program fragments) and modules (program functions and subroutines that implement aspects of the protection. These standard components are integrated into a program designed to be run on the protected device.

Some example protected modules and protected functions provided by the system include those listed below in Table 5.

TABLE 5

| | | DESCRIPTION OF |
|---|---|---|
| NAME OF PROTECTION | HOW IMPLEMENTED | PROTECTION |
| Memory overflow | Inserted into program flow | Protected device provides |
| attack detection | by integration of protected | and monitors “canary” |
| protection module | elements in function prefix | detect memory overflows |
| | and suffix. | (write beyond bounds). |
| Stack overflow | Inserted into program flow | Protected device executes |
| attack detection | by integration of protected | defensive code to limit |
| protection module | elements in function prefix | string copies. This can take |
| (aka Stack Protection) | and suffix. | the form of guards (canary |
| | | values) above and below the |
| | | data. If exceptions are |
| | | detected in the canaries, the |
| | | response is to stop the |
| | | execution of the stack. |
| Dynamic memory | Inserted into program flow | Protected device inserts |
| heap attack | by integration of protected | heap guard memory |
| protection module | elements into function prefix | protections and checks |
| | and suffix, or by creating | them. |
| | heap access “wrapper” code | |
| | that intercepts and checks | |
| | calls sentinel values in calls | |
| | that manipulate the heap. | |
| Control flow | Inserted into program flow | Protected device guards |
| Integrity | by integration of protected | internal execution with |
| protection module | elements into function prefix | control flow analysis that |
| (aka Control | and suffix, or by adding | monitors program calls and |
| Flow Integrity) | program flow check calls in | raises an exception if they |
| | various parts of the protected | are not called in the correct |
| | program. | order. |
| Syscall/language specific | Inserted into program flow | Protected device intercepts |
| library call parameter | by integration of protected | system (and common |
| checks (command | elements into function prefix | function) calls and compares |
| injection attacks) | and suffix, or by creating | parameter values with |
| protection module | syscall/library call | expected parameter values |
| | wrappers that intercept and | to detect injection attacks in |
| | check parameter values | real time. |
| | against expected values. | |
| Telemetry | Inserted into program flow | Protected device provides |
| module (2522) | by integration of protected | persisted telemetry functions |
| | elements that a) queues | for message collection, |
| | message and information for | aggregation, and |
| | transmission to a PES, b) | transmission to a PES. |
| | temporarily redirect program | |
| | flow to the telemetry module | |
| | so that persisted telemetry | |
| | functions may be performed. | |
| Control | Inserted into the protected | Protected device provides |
| module (2524) | program and called in | persisted command and |
| | response to a detected | control functions for |
| | program anomaly (e.g., from | receiving control |
| | the protected program | instructions from a PES and |
| | element or module that | executing them. |
| | detects the anomaly). | |
| | Periodically involved by the | |
| | protected program in order | |
| | to permit persisted control of | |
| | the protected device by the | |
| | PES. | |
| Specification | Inserted into the protected | Protected device receives |
| manager | program and called from the | and manages control |
| module (2526) | control module or telemetry | specifications and makes the |
| | module. | control specifications |
| | | available to the protected |
| | | program(s). |
| Protected Program | Inserted into unprotected | Provides program control |
| Elements and | program modules or | intercept points for |
| Program Modules | implemented as standardized | redirecting program control |
| | wrappers for library and | to protection code so that |
| | system calls. | protections may be |
| | | implemented and the |
| | | implementation for |
| | | detecting specific attacks |
| | | (by attack type) |

One particular aspect of the inserted program elements and protected program modules is that they permit the selective enabling/disabling of program protections under control specification control. Unlike existing systems for which program protections are statically enabled (and cause the resulting performance issues), the program elements as described here can enable/disable each of the protections on a program or function basis, allowing granular control of the protections. This permits protected programs to operate with reduced program protection enabled when they are not needed, and for additional program protections to be enabled if the protected device is suspected of being under attack (or other similar devices are being attacked).

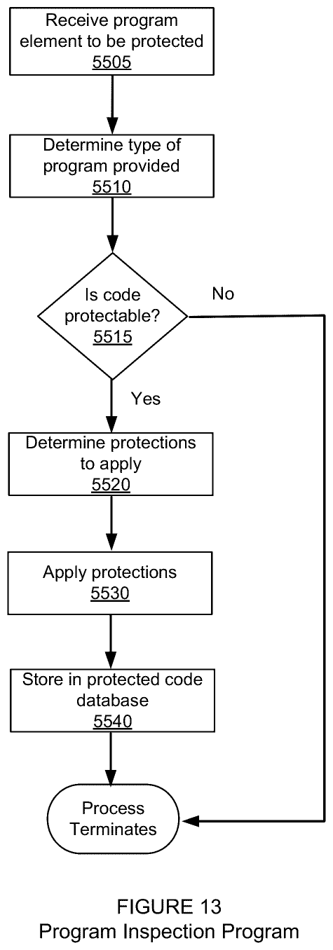

FIG. 13 illustrates an example process of protecting a program code against one or more attack types (attack types listed in Table 5).

The PES receives executable program instructions, function, subroutine, or relocatable executable program code to be protected in step 5505 and determines the type of code/program (e.g., source code, relocatable object code, binary executable code) that was received (step 5510).

The PES then determines whether the received code is protectable, i.e., whether it can have the desired protections applied (step 5515). If not (No branch of decision 5515), the process terminates.

If the code is protectable (Yes branch of decision 5515), the PES then determines the protections to be applied based upon code type and expected vulnerability of the code (step 5520). This determination may be made based upon one of more of the code inspection, flow analysis, or other static and dynamic code analysis techniques that are well understood in the art and are implemented in various program inspection programs. Once the determination that to code is protectable is made, the PES then applies the determined protections in step 5530.

The PES uses specialized protection application programs that determine and apply changes to the received program code to effect the selected protections. The specific changes to the received program code vary based upon the desired protection and are generally understood to those skilled in the art. In many cases, these changes result in the inclusion of protected program elements and/or protection modules comprising additional program code that effects the protection. For example, a provided executable binary program may be modified to call a specific protected program element that intercepts program execution prior to executing a vulnerable function in the provided program code and after completing (and before returning from) the function. The protected program element sets up the protection testing for one or more vulnerabilities and then passes control to the protected code. Similarly, the provided executable program may be modified to pass control to a second protected program element that tests to determine if the monitored vulnerability was encountered. If so, the second protected program element may pass control to a control module function that is added to the program to report and remediate the attacked device. If no vulnerability is detected, the second protected program element permits the function to return normally.

The modified program code (with callouts to the first and second protected program elements), along with any protection code referenced by the program elements is called a protected program module.

After the protections are applied to the received program code, the now protected program (code) is stored in a database of the system for subsequent use (step 5540) and the process terminates.

### 6.3.2.2.1 Example Stack and Data Segment Protections

In some implementations, the stack and data segment protections use methods of detecting stack, heap, and data memory block write violations (e.g., anomalous operation, either unintentional (e.g., improper program operation), or intentional (e.g., the result of an attack). Collectively, the set of memory write violation types are called memory exceptions. Traditional methods utilize either “canary” or “magic” numbers inserted at the start and end of the protected stack and data memory block. These techniques detect memory exceptions after the fact, e.g., after the stack, heap, or data area is corrupted. Other known techniques modify the generated code at compile time to add bounds checking code proper to calling a function or subroutine that copies into the protected data area. These additions swell the generated code significantly, limiting their utilization in memory constrained IoT devices. Still other known techniques replace the function or subroutine with a protected version of the same function or subroutine that includes bounds checking logic for each write. These techniques slow the operation of the program by regularly rechecking each memory operation before it occurs, in some cases rendering programs using the technique unusable.

When a function call that copies memory is intercepted, control is transferred to the protected element that protects the memory from overwrite. In this case, the call parameters including the address of the destination memory block (generally stored on the stack) are inspected against a list of known global variables and/or memory blocks to be protected. In some implementations, the list comprises all known global variables and memory blocks (and their size). In other implementations, the list comprises a short list recently accessed memory blocks. This short list of recently accessed memory blocks is far faster to traverse and test than previously described global lists comprising all stack, heap, and data memory blocks. If the address of the destination memory block is matched against one of the “short list” memory blocks (e.g., is contained within it), the separately operating protected element further evaluates the call parameters to determine the size of the target memory block, the size of the source to be copied, and whether a memory exception is expected to occur. Because we have intercepted the If so, the copy operation is stopped and an event is raised for the calling program. The event is handled as described elsewhere.

If the destination memory block is not located on the “short list”, it is added to the short list of recently accessed memory blocks and the memory operation is allowed to proceed using the original program logic of the protected program.

This technique is advantageous in that is far faster to execute than previously known methods and preemptively protects the memory of the protected program instead of detecting post-corruption memory using “canaries” to detect that an overwrite has occurred.

### 6.3.2.2.2 Example Command Injection Attack Protection

“Command Injection” attacks are attacks where the goal is to cause the execution of arbitrary commands on a device via a vulnerable. Protection against command injection attacks comprises techniques and methods that detect and/or stop command injection attacks. Since command injection attacks are often the result of unsafe coding practice in the application itself where unvetted, external information is used to construct or parameterize operating system level command, command injection attacks may be addressed by inspection of the operating code and the direct remediation of that code, or in a systemic fashion by modifying the executable to detect injection attempts when they are submitted for execution by operating system level commands.

Operating system level commands are typically accessed by function call or interrupt, depending upon the operating system. The operating system level commands comprise a command and one or more parameters that are passed along with the command. For example, a well-known operating system command in the Linux operating system (commonly used for embedded IoT devices) is execl( ). Similar operating system commands include system( ), chmod( ), chown( ), open( ), popen( ), and the like. For descriptive purposes, we call all protected calls “function calls”, without regard to how they are physically invoked by the protected program. In each case, the desired remediation is to detect that one or more parameter values that are being provided to these function calls that have been changed from a previously established/expected value(s) and to take remedial action based upon this detection.

In some implementations, the comparison between expected and actual parameter values is straightforward, e.g., the expected input parameter is a string or numeric value that is either invariant, minimally variant because changes only at program initialization, or variant because it changes each time a program executes. For example, if the parameter is the name of a file, and the variable part of the file name is the directory that the file is stored in, and the directory is determined at program installation time, the expected parameter is considered minimally variant. In an alternative example, the parameter is a user account number which changes from user to user of the device each time a different user accesses the device (e.g., a device that interacts with users and is installed in a home), the expected parameter would be considered variant.

In general, an approach to protecting against command injection attacks are techniques that identify attacks and render them inoperable. There are several methods of accomplishing this programmatically, which include:
rejection of variant parameters to protected function calls.
insertion or replacement of one or more portions of a parameter with an alternative value.
insertion or replacement of one or more portions of the parameter to render the parameter “safe.”

In a first example, one or more function call parameters may be determined to be “invariant”. Changes to a designated invariant parameter may cause a detection event for the protected device.

In an example of replacing one or more portions of a function call parameter with alternative values, in ways that render the function call parameter “safe” for use, the program alters the passed parameter in response to an execution time inspection of the parameter value. For example, an unsafe function call parameter may be provided as a string that is designed to be executed by the operating system, and specific operating system instructions are removed from the string, e.g., the output redirect character “>” or the command concatenation character “;” may be removed and/or altered from the function call parameter, and wildcard characters (e.g., “*” or “%”) may be replaced with spaces. Similarly, relative path names in file specifications may be altered to be absolute path names in accordance with a command specification.

In an example of insertion of one or more portions into the parameter in order to make the parameter safe, a command string passed as a parameter is altered to insert quotes (e.g., “) around the command string. When the quoted command string is passed to a system( ) function, the quotes prevent the execution of commands that are not defined until execution.

### 6.3.2.2.3 Creating a Command Injection Protected Program

The command injection inspection program of the PES inspects a program executable, inserts one or more protected program elements into the program, and determines the command injection parameter data elements required for safe execution. Inspection of the program executable occurs within the PES using a variety of static, dynamic, and hybrid (mixed static and dynamic) inspection techniques appropriate for the type of program executable. The result of the command injection inspection program is a protected program executable that includes protections against command injection attacks.

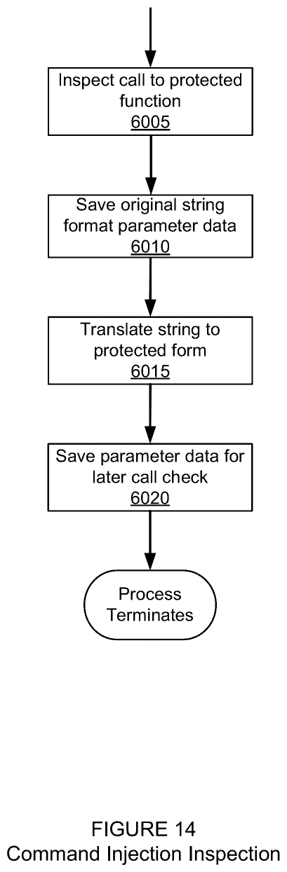

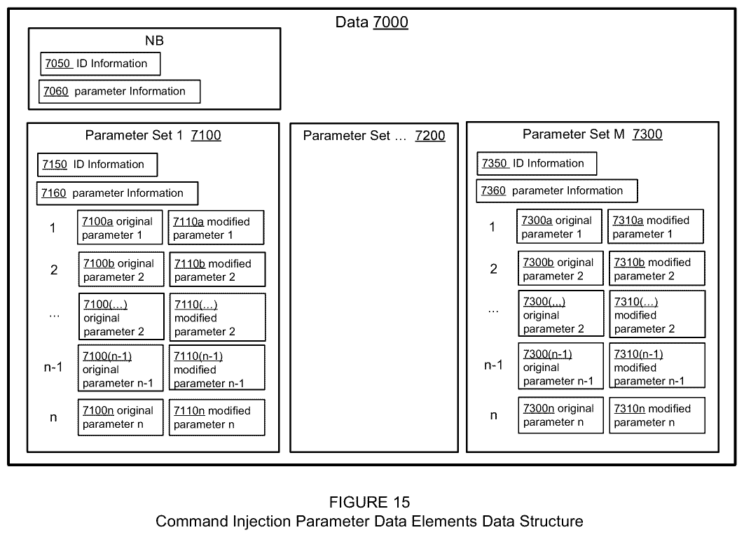

After identifying protected program element insertion points and insertion techniques, the command injection inspection program performs a process for each protected function like the one illustrated in FIG. 14. For each protected function call in the inspected program, the command injection inspection program inspects the function call and its parameters in Step 6005. The inspection may be performed using static analysis or by dynamic analysis of the inspected program execution in a controlled environment (e.g., a PES provided sandbox). The expected parameter values are determined and saved in a data structure, the command injection parameter data elements, illustrated in FIG. 15. Protected function invocation context information (e.g., FIG. 15, 7050) is also saved as part of the data structure. The invocation context information is used to differentiate different invocations of the same protected function from various portions of the protected program.

Processing then continues to step 6010, where the original protected function parameters data values are saved in the command injection parameters data elements structure. After saving the original parameters, the program parameters are modified in accordance with the technique selected by the command injection inspection program as shown in step 6015 and described with more detailed examples above. In the case of the example process illustrated in FIG. 14, the parameter being captured and modified is a string.

Processing then continued with process step 6020, where the modified parameter value (e.g., modified string) is saved to the data structure, and the completed data structure is saved for subsequent inclusion in the protected program.

Subsequent analysis may include additional parameter values in the same instance of the command injection parameter data elements data structure.

### 6.3.2.2.4 Command Injection Parameter Data Elements

FIG. 15 illustrates an exemplary command injection parameter data elements data structure protected program element. This data structure may be stored within the protected program itself or may be included by reference (such as in a shared library) by the protected program, allowing its periodic update.

Data element 7050 provides information about the invocation of the protected function for which the parameters are defined in the current instance of the data structure. The identification information may be derived from an identity of the program element calling the command injection protection module, from call trace information used by other protections, or other techniques that uniquely identify the protected function invocation.

Data element 7060 identifies the current expected parameter information to the command injection protection module, including data type, format, encoding, and related attributes of the parameters.

Parameter set 7100 identifies a set of parameters associated with a specific invocation of the protected function. The parameter set comprises ID information 7150 (similar to ID information 7050) that identifies the invocation instance for the parameters, and parameter information 7160 (similar to parameter information 7060), as well as pairs of original/modified parameter values (e.g., 7100a, 7100b) comprising the original and as-modified parameter values created as described above.

Additional parameter sets may be provided within the data structure to provide parameters for alternative attack and defense scenarios.

### 6.3.2.2.5 Command Injection Protection Module

The command injection protection module is a protected program element that is inserted into the protected program to protect one or more operating system command and/or function calls. The insertions occur in three parts; the insertion of redirection program elements that captures processor control. The redirection program element(s) may be inserted using any of the known insertion techniques (e.g., instruction substitution, symbol table modification, function wrappers), as described more generally above. The redirection program element serves to take control of the processor during normal protected program execution and redirect the processing to a second protected program element, the command injection protection module.

The command injection protection module is executed by the processor executing the protected program to detect and remediate any command injection attacks. The command injection protection module uses a third protected element, the command injection parameter data element, to determine if a command injection attack has occurred.

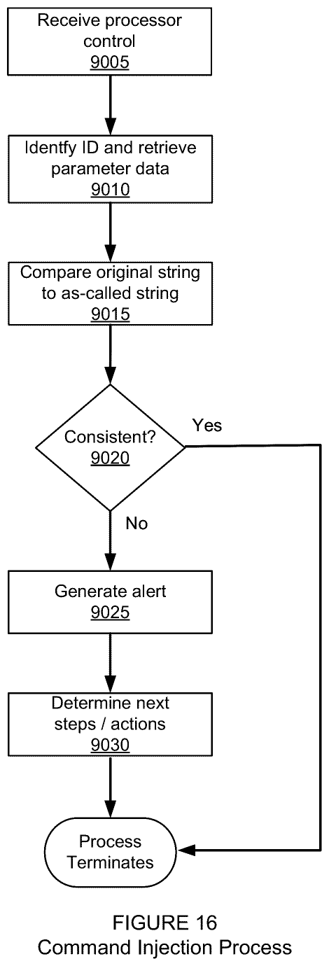

FIG. 16 illustrates an example process of the command injection protection module. The module starts processing when it is passed processor control by a protected program element in step 9005, and it identifies the ID that should be used to locate an appropriate command injection parameter data elements data structure. The module obtains the relevant data structure (either from within the protected program, from a protected program element that is dynamically provided to the protected program, by downloading it from a PES, from an in-memory copy of the data structure, or by locating the data structure in a database) in step 9010.

The module then compares the parameters passed to the protected function with the original parameter(s) described in the selected command injection parameter data elements data structure (step 9015). If a passed parameter and the previously determined parameter are consistent (Yes branch of step 9020), or if there are no further previously determined parameters to compare to, the protected function is executed using the corresponding protected parameter (e.g., modified parameter 7110a) from the data structure and the results returned to the caller. An alert may or may not be generated in this case to report the passed parameters.

If the passed parameter is inconsistent with the expected original parameter (No branch from 9015), the process generates an alert (step 9025) and determines the next processing steps/actions using one or more control specifications (step 9030). The process then takes those actions.

### 6.3.2.3 Receipt and Analysis of Sensor Vulnerability Reports

In some implementations, the PES may receive and process reports from network sensors reporting attack and/or attempted attacks. These network sensors may include firewall-based sensing, honeypots, host-based and network-based intrusion detection systems. In addition to the network sensors, the PES may receive and process incident reports and vulnerability notifications from network management and external security incident publishing services. These reports and notifications are received, parsed, optionally stored in a database, and associated with one or more protected devices. These reports and their associations may be optionally transmitted to other PES systems.

When a protected device (includes honeypot devices) detects an attack, it reports the details of the attack (e.g., attack source, attack type, actions taken) to the PES and awaits instructions from the PES. Reports of attacks against a protected device are received by a PES and processed, optionally stored in a database, and are optionally forwarded to other network systems. The reports may be optionally associated with one or more protected or unprotected devices based upon device ID, device type, specific device protections, and other criteria identified in the reporting specification.

The PES, upon receiving the attack report, generates PES-based alerts that describe the attack, and optionally takes additional actions to reconfigure/update the configurations of other protected devices on the network to guard against the attack. In this way, an attack against a protected device on the network results in the automated updating of other protected device configuration and protections. For example, if an attacker attacks a protected device using a “injection” exploit, the protected device receives the communications from the attacker, processes them, and at the point the protected program elements examine the string passed to the device and find that the passed string is inconsistent with the expected string, an operational exception is identified, recorded, and reported to the PES. The PES responds to the protected device's report as described above (or uses a predetermined response from a control specification), and the protected device operates in accordance with the provided response.

### 6.3.2.4 Receipt and Analysis of Device Telemetry

One aspect of monitoring protected devices is to receive and process device telemetry to detect if the device is being attacked or is comprised. In an implementation, the PES (2000) serves as a telemetry sink for data collected from and regarding protected devices.

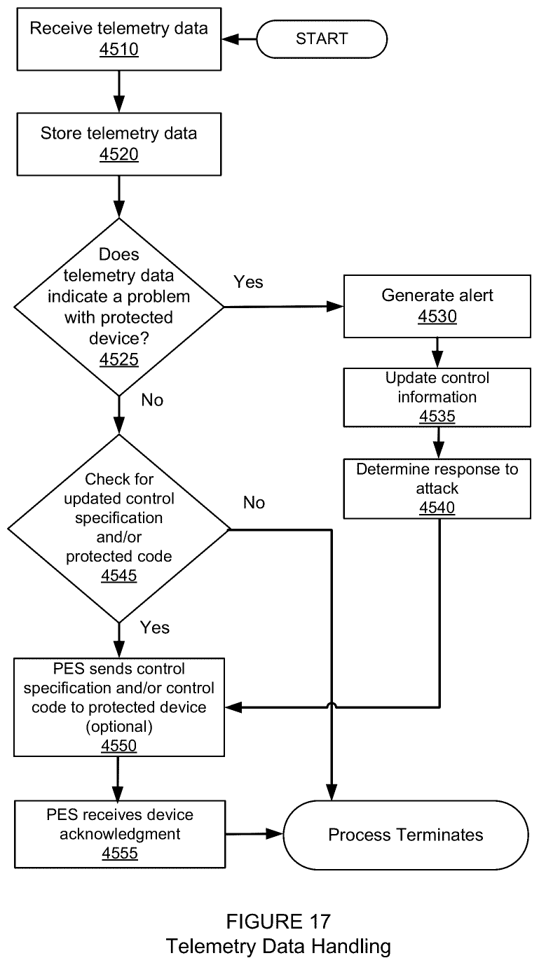

FIG. 17 illustrates an exemplary process performed by the PES to receive, classify, and respond to telemetry data from a protected device.

At step 4510, the PES receives the telemetry data from the protected device, and optionally checks the data for consistency.

At step 4520, the PES saves the received data in one or more data stores for subsequent analysis, for example to an internal database (2060) and/or one or more external database(s) (2070). It then further processes the received information in order to determine any further management actions required.

At step 4525, the PES then determines if the received telemetry data represents a problem with the protected device, for example, an attack against the protected device or anomalous operations of the protected device. In a first exemplary implementation, the PES receives, from the protected device(s), alerts related to device exceptions. In a second implementation, a telemetry parser/interpreter program operating on the PES parses telemetry data received from one or more protected devices to produce extracted alerts and execution exceptions based upon the received data.

The PES classifies the execution exceptions as anomalous or non-anomalous and associates one or more tags with each of the execution exceptions accordingly. This classification may be based upon a priori knowledge encoded in a classification program or from a PES attack definition stored in a database that specifies types of execution exceptions and their related exception data templates to support quick pattern matching for known exceptions resulting from attacks. In some implementations, the PES may use a trained machine learning model to determine whether the received telemetry data (and the data stored in a system database) represents an execution anomaly, an attack, or some other type of event.

The PES additionally classifies the received data, alerts, and exceptions that it receives from the protected devices. This classification may be based upon a priori knowledge encoded in a classification program, from execution exceptions that it has previously received and classified, or using information stored in a database that permits the quick pattern matching of known attacks and their classifications. In some implementations, the PES may use a trained machine learning model to determine if the received telemetry data (and the data stored in a system database) represents an anomaly, and attack, or some other type of event. In some implementations, the PES operates one or more attack classification programs that process the telemetry data to generate one or more attack classifications. In a first exemplary implementation, the PES operates an attack classification program that compares received telemetry data to a database of telemetry information and corresponding attack classifications. An attack classification program checks the received execution exemption telemetry data against a database of telemetry data to determine similarities. The attack classification program determines an attack classification, or determines some other type of activity is occurring, based on comparing received telemetry data to the database and matching the received telemetry data to at least one entry in the database.

In a second exemplary implementation, the PES operates an attack classification program that uses or includes at least one trained attack classification machine learning (ML) model (2112) to determine a type of attack, or other non-attack activity, based on received telemetry data. In an example, an attack classification ML model is trained using historical telemetry data, for example telemetry data collected by the same and/or one or more other PES from protected devices during one or more identified historical attacks. In some implementations, the attack classification ML model can be retrained as new data is acquired during operation.

The PES thus further determines, based on the alerts and reports, one or more attack classifications, and from that determination, determines one or more responses. This classification process may occur at the time of receipt or may be performed at a later time.

The telemetry parser/interpreter program saves the tagged alerts and execution exceptions to a database or tags one or more execution exceptions already contained within a database. In some exemplary implementations, the telemetry parser/interpreter program only saves specific execution exceptions to the execution exception database, for example execution exceptions that are useful for classifying one or more types of attacks.

Based upon the classifications made, if there was alert or anomaly identified (Yes branch of step 4525), the PES generates an alert to the PES (for example, to the user interface component) at step 4530. The alert causes the PES to run additional programs to generate and/or update the control information associated with the device (step 4535), and then to determine a response to be made to the device (4540). After the response is determined (e.g., update control specifications, update protected program elements), the PES then transmits the response to the device (step 4550). In a first implementation, the response takes the form of updated protected program materials, e.g., an updated control specification and/or updated protected program elements, protected program modules, or entire protected programs. In other implementations, the response includes sending instructions to the protected device on how it should proceed, e.g., to terminate the program, to pass control to the control module and enter a safe mode pending rehabilitation. These instructions are communicated to the protected device's control module where they are implemented. In still other implementations, the response is to take no action.

The PES then receives the device acknowledgement of the updated protection materials and/or instructions (step 4555), and the process ends.

If the telemetry data does not indicate that there is a problem or anomaly with the protected device execution (No branch of step 4525), the PES then checks its database to determine if there are updates pending delivery to the protected device (step 4545). These updates may have been generated by an attack on a different device, or by a PES user entering different protection criteria or protection strategies into the user interface. If there are no updates to send to the protected device (No branch of decision 4545), the process ends.

If there are updated protected materials to be transmitted (Yes branch of decision 4545), the PES transmits these updated protection materials to the protected device (step 4550), receives an acknowledgement from the device (step 4555), and the process ends.

### 6.3.2.5 Command and Control of Protected Devices

Protected devices may have an optional control module incorporated into them that provides a persisted capability for the PES to implement commands that effect one or more actions as part of the device management. Some of these commands include:
monitor other devices for the same type of attack;
turn on telemetry (and/or capture additional data);
enable additional attack detection program elements on the protected device;
configure the device firewall to block the attack;
geographically limit control specification (to areas more at risk for that type of attack);
restart/reboot the protected device;
kill/terminate a process (program) in a multi-process environment;
“brick” (render inoperable) device (as a last resort);
download updated protected program materials.

Other actions may be provided by the control module without deviating from the scope of the disclosure.

### 6.3.2.6 Remediation Control of Attacked Devices

The PES determines one or more remediation actions to undertake in response to an attack classification. In one exemplary implementation, the PES is configured with one or more pre-determined remediation actions that should be enacted in response to a particular identified attack. In another exemplary implementation, the PES operates one or more trained ML models to select remediation actions. For example, the PES includes one or more trained ML models that select remediation based on an attack classification or based on execution exception telemetry data corresponding to a classified attack, for example telemetry data that was used to classify the attack and/or telemetry data that was collected contemporaneously to data used to classify the attack.

The one or more remediation actions determined by the PES can include, for example, altering configuration settings on one or more protected devices, for example enabling or disabling specific protections on a protected device. In some implementations, remediation actions include configuring specific details of specific protections, for example enabling or disabling specific path checks or strings.

The PES supports multiple methods for generating and communicating, to protected devices, remediation actions and for controlling the protected device during processing of anomalous operation.

### 6.3.2.7 Machine Learning (Optional) as a Remediation Aid

The PES can use one or more machine learning (ML) models to determine control specification changes, i.e., new or updated control specification(s) to be downloaded to one or more protected devices. A first exemplary ML model generates one or more control specification changes based on a classification of an attack generated by the PES. A second exemplary ML model generates one or more control specification changes based on collected telemetry data; for example, based on one or more exemption executions parsed and classified by the PES. In an exemplary implementation, a ML model is re-trained using data collected by the PES. In this manner, as the system learns more, if it sees a new attack designed to get around existing fixes, it can modify the one or more responses by making further changes to control specification, without regenerating an executable.

In a further example, a PES identifies an attack on a first device and modifies control specification for the first device. The PES further determines additional devices that are similar to the first device (e.g., by identifying devices with same firmware as the first device) and pushes the modified the control specification to the additional devices.

### 6.3.2.8 Control Specification Changes

In some implementations, the one or more remediation actions may include alterations to one or more control specification(s) to change protected device configuration (e.g., to configure the device to perform additional monitoring). In other words, the PES can use control specification(s) to define protected device updates in response to specific attacks that it recognizes. The one or more remediation actions can include generation of, or modification of, one or more control specification(s) for one or more protected devices. In an exemplary implementation, the PES operates a control specification manager program to manage control specifications, e.g., generate and save one or more control specification(s) and/or to modify and save an existing control specification for one or more protected devices in response to an attack classification. A first example method includes generating or modify at least a portion of control specification for a protected devices and communicating the generated or modified control specification to the protected device, and in some instances to one or more additional protected devices. A second example method includes completely regenerating the executable and pushing to regenerated executable from the PES. To save system resources, the PES completely regenerates control specification(s) on an infrequent basis. Control specification modification occurs independently of other remediation activities or may be instigated based upon a detection and subsequent classification of an anomaly or attack.

Control specification changes can include, for example, instructions for the device to perform one or more of the following actions:
monitor other devices for same type of attack;
turn on telemetry (and/or capture additional data);
enable additional attack detection program elements on the device;
configure the device firewall to block attack;
geographically limit control specification (to areas more at risk for that type of attack);
restart/reboot device;
kill/terminate a process (program) in a multi-process environment;
“brick” (render inoperable) device (as a last resort);
download updated protected program materials from a PES.

Other specified actions may be provided without deviating from the intent of this specification.

The PES then downloads the new or modified control specification(s) into one or more protected devices. In this manner, the PES can turn on or off specific protections on protected devices when the devices implement the new or modified control specification, update the protections and detections provided by protected elements, and otherwise control the operation of the protected device.

### 6.3.3 Examples of Types of Attack, and PES Response

Table 6 below lists examples of types of anomalies and external attacks (as recognized by the PES based on telemetry) and the response by the protected device and the PES upon detection of the anomaly. Examples of these techniques include mitigation of stack-based attacks and dynamic memory-based attacks. See, for example, U.S. Pat. No. 11,231,948 entitled “Applying security mitigation measures for stack corruption exploitation in intermediate code files,” U.S. Pat. No. 11,176,060 entitled “Dynamic memory protection,” U.S. Pat. No. 11,119,798 entitled “Applying control flow integrity verification in intermediate code files,” and U.S. Pat. No. 10,983,923 entitled “Dynamic memory protection,” each of which is incorporated herein by reference.

The use of field-replaceable protected element methods extends these techniques to further allow the protection techniques to be modified and configured “on the fly”, to protect only those portions of the protected device that require protection, and permits a compromised device to be rehabilitated and re-established on the network with new protections. More techniques are being developed as new attacks and detection methods evolve, adding these techniques to the system described herein is within the scope of this specification. The ability to dynamically add additional attack remediation techniques to a running and deployed protected device is one of the improvements of this system. The following table summarizes protections by attack type, the actions taken by the protected device to protect against the attack, and the actions taken to convert a device program into a protected program.

TABLE 6

| | ACTION BY | ENABLING |
|---|---|---|
| EXTERNAL ATTACK | PROTECTED DEVICE | PROTECTION ACTION |
| Overflow attack | Protected device provides and | Insert memory exception |
| (protected by Memory | monitors for memory | detection protected |
| Protection module) | exceptions, either using a | elements and modules into |
| | “canary” value to detect | protected executable, |
| | memory overflows (write | and/or enable previously |
| | beyond bounds), or | inserted protected |
| | alternatively, provides | elements. |
| | parameter checking to prevent | |
| | overflow writes (and related | |
| | memory exceptions) from | |
| | occurring. | |
| Stack-smashing attack | Protected device executes | Insert “stack smashing” |
| (protected by Stack | defensive code to limit string | protected elements into a |
| Protection module) | copies. This can take the form | protected executable, |
| | of guards (canary values) above | and/or enable previously |
| | and below the data, or may be | inserted protected |
| | performed using parameter | elements. |
| | checks as described above. If | |
| | exceptions are detected, the | |
| | response is to stop the execution | |
| | of the stack. | |
| Dynamic (heap) | Protected device protects the | Insert “heap protection” |
| memory attack | heap against memory | protected elements and |
| (protected by | exceptions. If exceptions are | modules into a protected |
| Memory Protection | detected, the device takes the | executable, and/or enable |
| module) | defined response. | previously inserted |
| | | protected elements. |
| Control flow | Protected device guards internal | Insert control flow |
| alteration exploits | execution with control flow | monitoring and protection |
| (protected by | analysis that monitors program | protected elements and |
| Control Flow | calls and raises an exception if | modules into a protected |
| Integrity module) | they are not called in the correct | executable, and/or enable |
| | order. | previously inserted |
| | | protected elements. |
| System call/ | Protected device intercepts | Insert system call |
| injection exploits | system (and common function) | monitoring protected |
| (protected by | calls and compares parameter | elements and modules into |
| Command | values with expected parameter | a protected executable, |
| Insertion attack | values to detect injection attacks | and/or enable previously |
| protection module) | in real time. | inserted protected |
| | | elements. |

### 7 EXAMPLES

The following Examples are provided to illustrate certain aspects of the present technology and to aid those of skill in the art in the art in practicing the technology. These Examples are in no way to be considered to limit the scope of the technology in any manner.

### 7.1 Deployment of “Honeypots” Using Protected Execution Techniques

In an example deployment of the technology, commercially available network devices such as routers, wireless access points, and IoT sensors are obtained from standard commercial sources. These commercial devices do not have protected execution, persistent monitoring, nor device recovery capabilities in their “shipped from factory” form. Existing commercial devices are used because they present a more authentic network presence than devices that simulate known network devices.

Once obtained, the “honeypot” network device has one or more of its executable programs replaced with protected execution programs constructed using techniques and replaced on the device as described herein, and has its configuration secured in accordance with current industry best practices. The “honeypot” device is then connected to a network, where it is registered with a PES (either manually or automatically) for ongoing monitoring and management. The now-registered “honeypot” is then left connected to the network to detect attacks against the network.

Malicious attackers (e.g., hackers) generally use well known techniques to attack the honeypot device, so honeypots that regularly update their detection capabilities as new attacks and exploits are discovered are effective at detecting these attacks on the honeypot monitored network.

In accordance with the above specification, the honeypot device has its protected programs and its control specifications updated on an as-needed basis by a PES. Sometimes, these updates are to the protected programs to add or change functionality of one or more protected program elements and/or protected modules. In other instances, the updates are to the control specification that tell the protected device what to monitor and how to report any findings if an anomalous condition is detected. One aspect of the system is that the updates are generated by the PES, not only in response to detections/reports by the protected device, but additionally because of detections/reports by other protected devices on the network. In some instances, the information required to update the protected program elements and/or protected modules is received from a system external to the PES (in the form of alerts or reports from external systems) or is manually entered through the user interface. Note that these updates may occur asynchronously for different protected devices on the network, and may vary based upon the type of device, class of device, manufacturer of device, protected program versions, and similar protected device characterizations.

A honeypot device is registered with the PES as part of a network discovery process when a PES is deployed on a network or using manual registration by a user.

### 7.2 Examples of Protection vs. Command Insertion

The described systems and methods provide protection against command insertion attacks against protected executables. In typical use, the command insertion is formed by a malicious user providing extra or extraneous content to a prompt or response required by the attacked program. The attacked program takes this response and in the process of using the response, constructs one or more strings that are used by the program. These strings are typically passed to a low level or system call/function such as system(3), pexec(2), open(2)/fopen(3), and the like. Note: all example systems calls are given for Linux/Unix implementations, additional calls with different names and/or operating systems may also be protected). The low level/system call executes using the passed in string. In attacked programs, the contents of the string contains extra characters that are interpreted by the low level call/function as additional commands. For example, if a user is prompted by the program for an account number by the attacked program, the program may create a string including the account number (e.g., “cat 12345678”) and pass that string to the “system( )” function call for execution (e.g. list the contents of file 12345678). A malicious user might enter “12345678; rm 12345678” as the entered account number, and if the attacked program does not properly check the entered data, would construct the string “cat 12345678; rm 12345678”. In this example, executing the string provided after the attack might cause the file “12345678” to be deleted from the system after listing it.

To guard against this type of attack, the system modifies the program by inserting program elements that intercept calls to the system( ) function. These intercepts may be performed using any of the above described methods, for example, by providing program elements that provide an alternative entry point named “system” (e.g., a function wrapper), trapping the function call at the time it is made, altering a shared library to redirect calls to the system function to an alternative program element, and the like. The captured system call is then processed as described above.

For purposes of a first example, the trapped system call of a protected program captures the string parameter and saves it for subsequent uploading to a PES for further analysis. The specification for processing these types of operations is defined in a parameter set such as the one described in FIG. 15. For example, this technique may be used when the protected program is being used as a “honeypot” and the goal is to detect and capture all possible information about an ongoing attack, or when the risk of an attack against the protected program is fairly low.

In a second example use, the string parameter to trapped system call of a protected program is inspected and compared against one or more patterns of known good (or bad) attack strings defined in a parameter set. For example, the parameter set may define a known attack string as “*;*” which will match any string with a semi-colon (“;”) in it. If the string parameter matches this pattern, the protected program responds to a string match as defined in the parameter set, such as stopping execution of the attacked program, changing the operation of the operating protected program, and the like. In this way, a set of known attack detection and response templates may be created and used by protected programs to automatically detect and protect against common classes of command injection attacks (e.g., injecting additional commands using a concatenated command separator).

### 7.3 Conclusions

It will also be recognized by those skilled in the art that, while the technology has been described above in terms of preferred implementations, it is not limited thereto. Various features and aspects of the above-described technology may be used individually or jointly. Further, although the technology has been described in the context of its implementation in a particular environment, and for particular applications, those skilled in the art will recognize that its usefulness is not limited thereto and that the present technology can be beneficially utilized in any number of environments and implementations where it is desirable. Accordingly, the claims set forth below should be construed in view of the full breadth and spirit of the technology as disclosed herein.

We claim:

1. A method for protecting a computing device comprising a processor and configured for connection to a network, the method comprising:
obtaining at least part of a program configured to operate on the device;
modifying the program to create a protected program by including one or more additional program elements that provide at least one aspect of protection against a threat or attack against a program operating on the device;
making at least part of the protected program available to a network connected computing device.

2. The method of claim 1, further including the steps of:
saving the protected program to a data store; and
providing the protected program to the device for subsequent execution by the device processor.

3. The method of claim 1, wherein modifying comprises including first and second protected program elements and/or protected program modules to the protected program, the first and second protected program elements and/or protected program modules respectively effective to detect and/or stop and/or report different network-based attacks within a program operating on the device, and the modifying further comprises configuring the protected program to execute the protected program elements and/or protected program modules.

4. The method of claim 1, wherein the modifying includes providing a capability enabling specification, and the steps of configuring the first and second protected program elements and/or protected program modules, thereby allowing differing protected program elements to be dynamically enabled or disabled in accordance with the capability enabling specification.

5. The method of claim 1, wherein further including an external device providing one or more program elements and/or protected program modules and/or capability specifications to the protected device.

6. The method of claim 1, wherein modifying comprises including a protected program element and/or protected program module configured to enable one or more of (a persisted telemetry function, a persisted command and control function, a protection enabling/disabling function).

7. The method of claim 1, wherein providing comprises providing the protected program to the device before deploying the device on the network.

8. The method of claim 1, wherein providing comprises providing a protected program and/or protected program elements and/or protected program modules to a device during the device boot process.

9. The method of claim 1, wherein providing comprises providing at least one protected program element and/or protected program module after the device is deployed and connected to the network.

10. The method of claim 1, wherein providing comprises providing one or more portions of the protected program to the device as a shared library and/or as a binary executable.

11. The method of claim 1, wherein modifying includes replacing one or more protected program elements and/or program modules of the program without recreating the protected program.

12. A method for operating a protected device including a processor and connected to a network, the method comprising:
providing a protected device comprising at least one protected program effective to provide at least one aspect of specification-defined protection against network-based attacks; and
executing the protected program on the protected device processor in accordance with a specification to protect the protected device from network-based attacks.

13. A method of claim 12, further including forming the protected device by downloading from a remote computing device one or more portions of a protected program into the device, the downloaded portions comprising one more of a set of protections: (protected program element(s), protected program module(s), control specifications) to provide one or more protection functions in the set comprising (specific attack detection and/or protection, a protection enabling/disabling function, a persisted telemetry function configured to communicate with a remote computing device, a persisted command and control function)

14. A method of claim 13, including downloading one or more portions of a protected program into the device when the protected device is booted and connected to the network.

15. A method of claim 13, further including updating the protected device by downloading one or more protected program portions into the protected device after the device is deployed.

16. A method of claim 13, wherein the downloading comprises downloading a shared library comprising portions of the protected program.

17. A method of claim 13, further including operating the persisted telemetry function to communicate metrics or suspected attack notifications from protected program elements of the protected program.

18. A method of claim 17, further including operating the persisted telemetry function to transmit at least some of the metrics or suspected attack notifications generated by one or more of the specific attack detection and/or protection functions to the remote computing device.

19. A method of claim 13, further including the persisted command and control function operating to communicate with the remote computing device and receive control instructions from the remote device.

20. A method of claim 19, further including operating the persisted command and control function to implement one or more instructions received from the remote device.

21. A method of claim 13, further including operating the protected device to include one or more functions selected from the set comprising (detecting an attack during the execution of the protected program, providing one or more detection results to the persisted telemetry function, taking an action to prevent further execution of the attack).

22. A method of claim 21, wherein taking the action includes pausing or terminating a current execution of the protected program and/or transferring control from the protected program to the command and control program element and/or performing one or more actions specified by the command and control program element and/or performing at least one action specified in a capability enabling specification.

23. A method of dynamically protecting a program execution characterized by:
providing a dynamic protection application for executing on a device to be dynamically protected, the dynamic protection application having the capability to create a protected program in the executing memory of the protected device;
loading a dynamic library comprising at least one of at least one of a (protected program element(s), protected program module(s), control specifications) within a memory space associated with the dynamic protection application;
loading an application program to be protected into memory,
associating the memory space containing the loaded dynamic library with the loaded application program loading, and
modifying a run time call sequence of the application program to redirect program execution to one or more of the protected program elements/modules within the loaded dynamic library, creating a dynamically protected program loaded in the memory of the device.
